(19) United States
(12) Patent Application Publication
(10) Pub. No.: US 2023/0197306 A1
(43) Pub. Date: Jun. 22, 2023

(54) FULLY CERAMIC ENCAPSULATED RADIOACTIVE HEAT SOURCE

(71) Applicant: ULTRA SAFE NUCLEAR CORPORATION, Seattle, WA (US)

(72) Inventors: Francesco Venneri, Seattle, WA (US); Danyal Turkoglu, Seattle, WA (US); Michael John Eades, Seattle, WA (US); Christopher Morrison, Seattle, WA (US); Paolo Francesco Venneri, Seattle, WA (US)

(21) Appl. No.: 17/946,558

(22) Filed: Sep. 16, 2022

Related U.S. Application Data
(63) Continuation-in-part of application No. 17/887,083, filed on Aug. 12, 2022.
Application No. 17/887,083 is a continuation-in-part of application No. 17/785,690, filed on Jun. 15, 2022.
Application No. 17/785,690 is a continuation-in-part of application No. 17/787,764, filed on Jun. 21, 2022.
(60) Provisional application No. 62/971,898, filed on Feb. 7, 2020.
(60) Provisional application No. 62/971,898, filed on Feb. 7, 2020.

(51) Int. Cl. G21H 1/10

(52) U.S. Cl. CPC G21H 1/103

(57) ABSTRACT

A chargeable atomic battery (CAB), such as a fully ceramic encapsulated radioactive heat source, includes a plurality of CAB units and a CAB housing to hold the plurality of CAB units. Each of the CAB units are formed of a precursor compact including precursor material particles embedded inside an encapsulation material. The precursor material particles include a precursor kernel formed of a precursor material that is initially manufactured in a stable state or an unstable state and convertible into an activated material via irradiation by a particle radiation source. The precursor material particles can include one or more encapsulation coatings surrounding the precursor kernel. The precursor material can include Neptunium-237 and the activated material can include Plutonium-238. A radioisotope thermoelectric generator can include thermoelectrics coupled to the CAB units to convert radioactive emissions of the activated material into electrical power.

### CROSS-REFERENCE TO RELATED APPLICATIONS

This application is a continuation-in-part of U.S. patent application Ser. No. 17/887,083, filed on Aug. 12, 2022, the entirety of which is incorporated by reference herein.

U.S. patent application Ser. No. 17/887,083 is a continuation-in-part of U.S. patent application Ser. No. 17/785,690, filed on Jun. 15, 2022, titled “Chargeable Atomic Battery and Activation Charging Production Methods”; and a continuation-in-part of U.S. patent application Ser. No. 17/787,764, filed on Jun. 21, 2022, titled “Chargeable Atomic Battery with Pre-Activation Encapsulation Manufacturing,” the entireties of which are incorporated by reference herein.

U.S. patent application Ser. No. 17/785,690 is a National Phase Application of International Application No. PCT/US2021/016982, filed on Feb. 7, 2021, published as WO 2021/159043 on Aug. 12, 2021, the entirety of which is incorporated by reference herein. International Application No. PCT/US2021/016982 claims priority to U.S. Provisional Patent Application No. 62/971,898, filed on Feb. 7, 2020, titled “Chargeable Atomic Batteries (CABs) enabled by ceramic encapsulation and activation charging production methods enabling cost-effective and scalable radioisotope heaters, electric generators, and x-ray sources,” the entirety of which is incorporated by reference herein.

U.S. patent application Ser. No. 17/787,764 is a National Phase Application of International Application No. PCT/US2021/016980, filed on Feb. 7, 2021, published as WO 2021/159041 on Aug. 12, 2021, the entirety of which is incorporated by reference herein. International Application No. PCT/US2021/016980 also claims priority to U.S. Provisional Patent Application No. 62/971,898, filed on Feb. 7, 2020, titled “Chargeable Atomic Batteries (CABs) enabled by ceramic encapsulation and activation charging production methods enabling cost-effective and scalable radioisotope heaters, electric generators, and x-ray sources,” the entirety of which is incorporated by reference herein.

### TECHNICAL FIELD

The present subject matter relates to examples of a chargeable atomic battery, such as a fully ceramic encapsulated radioactive heat source, that includes pre-irradiation encapsulation of a precursor material in fully ceramic encapsulation followed by activation in a neutron field and then is allowed to cool to desired radioactivity levels. The radioactive heat source can then be used as a nuclear heat source for direct heat applications as well as electricity production. The radioactive heat source also enables a method useful for the transmutation of transuranic nuclear waste.

### BACKGROUND

Conventional atomic batteries, sometimes referred to as nuclear batteries or radioisotope generators, typically include Plutonium-238 (Pu-238). However, mass commercialization of atomic batteries faces multiple key challenges, including: (1) safety; (2) technical/manufacturing; (3) regulatory framework compliance; and (4) marketability.

Following are some of the technical problems in the field of atomic batteries that currently impede commercialization. There is not a robust method of encapsulating and isolating nuclear material from environmental release. Challenges in production and the complexity of containing the nuclear material have also limited the application of atomic batteries.

### SUMMARY

The various examples disclosed herein relate to nuclear technologies for a chargeable atomic battery system 192 that includes a chargeable atomic battery 190 for space, terrestrial (e.g., land or sea) applications. To improve safety and reusability, the chargeable atomic battery 190 includes CAB units 104A-G formed of precursor material particles 151A-N embedded inside an encapsulation material 152. The precursor material particles include a precursor kernel 153 formed of a precursor material 159. In one example, precursor material 159 can be initially manufactured in a stable state that is non-radioactive or an unstable state that is an unstable radioisotope. For example, in the unstable state, the precursor material 159 can be a radioactively-unstable nuclide. Precursor material 159 can be rechargeable by a particle radiation source (e.g., nuclear reactor core) 101.

Chargeable atomic battery 190 can possess one-million times the energy density of state-of-the-art chemical batteries and fossil fuel. For locations that do not possess access to the sun or other energy sources, the chargeable atomic battery 190 can generate heat, electrical energy, and passive x-ray radiation sources in a relatively large quantity and in a small form factor. Relevant use cases for the chargeable atomic battery 190 include small satellites operating far from the sun, electronics on the moon attempting to survive the lunar night, underwater vehicles to explore the depths of the ocean, and low-power heat in remote regions, such as Canada, northern Europe, and Asia. These CAB technologies are intended for use in locations without other sources of power, and in extreme environments where robust, long-lived operation is key. These locations include space, terrestrial, underground, and underwater.

To charge and use a chargeable atomic battery 190, the chargeable atomic battery 190 is placed in proximity to a particle radiation source 101. Subatomic particles 160A-N from the particle radiation source 101 bombard CAB units 104A-G within the chargeable atomic battery 190, irradiating a precursor material 159 selected due to a propensity to convert from a stable state or an unstable state to a radioactive state under subatomic particle 160A-N bombardment. The precursor material 159 can be further selected due to a propensity to convert to a non-radioactive state after releasing radiation particles 161A-N in the radioactive state. For example, the chargeable atomic battery 190 can be utilized as a radioisotope thermoelectric generator (RTG) that includes thermoelectrics 305 (e.g., an array of thermocouples) to convert the heat released by the decay of the activated material 162 in a radioactive state (e.g., activated state) into electricity by the Seebeck effect. The RTG can be used in a space exploration application, for example.

An example chargeable atomic battery 190 includes a plurality of CAB units 104A-G. Each of the CAB units 104A-G are formed of a precursor compact 158 that includes precursor material particles 151A-N embedded inside an encapsulation material 152. The precursor material particles 151A-N include a precursor kernel 153 formed of a precursor material 159 that can be initially manufactured in a stable state or an unstable state and convertible into an activated material 162 via irradiation by a particle radiation source 101. Chargeable atomic battery 190 further includes a chargeable atomic battery 191 housing to hold the plurality of CAB units 104A-G.

Another example chargeable atomic battery 190 includes at least one CAB unit 104A formed of a precursor material 159 embedded inside an encapsulation material 152. The chargeable atomic battery 190 further includes a chargeable atomic battery housing 191 to hold the at least one CAB unit 104A. The precursor material 159 can be initially manufactured in a stable state or an unstable state and convertible into an activated material 162 via irradiation by a particle radiation source 101. A radioisotope thermoelectric generator can include the at least one CAB unit 104A and thermoelectrics 305 coupled to the at least one CAB unit 104A to convert radioactive emissions of the activated material into electrical power (e.g., electricity production). Alternatively, the chargeable atomic battery 190 can be used as an independent heat source for direct heat applications.

An example chargeable atomic battery fabrication method 600 includes providing a plurality of precursor material particles 151A-N (step 605). The precursor material particles 151A-N include a precursor kernel 153 formed of a precursor material 159 that can be initially manufactured in a stable state or an unstable state and convertible into an activated material 162 that is an activated state via irradiation by a particle radiation source 101. The chargeable atomic battery fabrication method 600 further includes mixing the plurality of precursor material particles 151A-N with ceramic powder to form a mixture (step 610). Additionally, the chargeable atomic battery fabrication method 600 further includes placing the mixture in a die (step 615), pressing the mixture in the die to form an unsintered green form (step 616), and sintering the unsintered green form into a CAB unit 104A (step 620). In addition, the chargeable atomic battery fabrication method 600 can include additive manufacturing of the chargeable atomic battery 190.

An example chargeable atomic battery method 700 includes placing a precursor material 159 of a CAB unit 104A in proximity to a particle radiation source 101 (step 710). The chargeable atomic battery method 700 further includes during an initial charging cycle of a chargeable atomic battery 190, converting an initial portion of the precursor material of the CAB unit 104A from a stable state or an unstable state into an activated material 162 that is an activated state via the particle radiation source 101 (step 715). The chargeable atomic battery method 700 further includes emitting radiation from the activated material 162 of the chargeable atomic battery 190 (step 720). The chargeable atomic battery method 700 further includes converting the emitted radiation from the activated material 162 into electrical power via thermoelectrics 305 of the chargeable atomic battery 190 (step 725).

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1A illustrates a chargeable atomic battery with multiple CAB units, being charged by free neutron fluence emitted by a nuclear reactor core.

FIG. 1B illustrates a single CAB unit of the chargeable atomic battery of FIG. 1A, built out of an encapsulation matrix encompassing precursor material particles, as well as a detail view of an example precursor material particle.

FIG. 1C illustrates an example precursor material particle being bombarded with the free neutron fluence from FIG. 1B.

FIG. 1D illustrates the now activated precursor material particle from FIG. 1C emitting subatomic particles in response to being bombarded by the free neutron fluence from FIG. 1C.

FIGS. 2A-D illustrate an atom from the example precursor material particle from FIGS. 1B-D being bombarded by a free neutron, changing ionization, and then later emitting a subatomic particle and transmuting into another element.

FIGS. 3A-D illustrate an unused CAB unit being charged by a nuclear reactor core, then creating electricity, as well as the relative percentages of select elements within the CAB unit.

FIGS. 4A-D illustrate a previously used but depleted CAB unit being fully recharged by a nuclear reactor core, then creating electricity until the battery is completely and permanently expended, as well as the relative percentages of select elements within the CAB unit.

FIGS. 5A-B illustrate a chargeable atomic battery with coupled thermoelectrics having an individual CAB unit charged by a nuclear reactor core separately from the housing of the chargeable atomic battery.

FIGS. 5C-D illustrate return of the charged CAB unit to the chargeable atomic battery and attachment of a radiation shield.

FIG. 6 is a flowchart depicting a chargeable atomic battery fabrication method for manufacturing an unused, uncharged, chargeable atomic battery.

FIG. 7 is a flowchart depicting the process for initially charging, using, and recharging and reusing a chargeable atomic battery.

FIG. 8 is a flowchart streamlining FIGS. 6 and 7 to illustrate the selection, manufacturing, activation, and power production steps.

FIG. 9 is a chart of activated isotopes, their half-lives, parent isotopes, and power output over a range of days.

FIG. 10A illustrates a chargeable atomic battery (CAB) that includes a CAB unit.

FIG. 10B is a cutaway view of the CAB unit of FIG. 10A.

FIG. 11A illustrates a CAB that includes a CAB stack and a top view of the CAB stack.

FIG. 11B is a cutaway view of the CAB stack of FIG. 11A containing a few dozen CAB units of FIGS. 10A-B.

FIG. 12 illustrates a CAB that includes a CAB pack, in which the CAB pack includes the CAB stack of FIGS. 11A-B, an ablative aeroshell, and an x-ray shield shown in a cutaway view.

FIG. 13 illustrates a CAB system that includes an irradiation capsule containing six CAB units of FIGS. 10A-B undergoing irradiation from subatomic (e.g., neutron) particles from a particle radiation source that is a fission nuclear reactor core.

FIG. 14 is a flowchart showing a CAB manufacturing method for producing a CAB.

FIG. 15 illustrates activation isotope production governing equations describing the activation of an activated material (radionuclide) from a precursor material.

FIG. 16 illustrates a reaction pathway table for several particle radiation activation pathways.

FIG. 17 depicts a CAB encapsulation chart of three types of encapsulation techniques for the CAB units of FIGS. 10A-B compared to a traditional approach with no encapsulation.

FIG. 18A illustrates a precursor kernel with several precursor encapsulation coatings and a callout of a single atom of Thulium-169 of the precursor kernel.

FIG. 18B illustrates a neutron interacting with the Thulium-169 of the precursor kernel of FIG. 18A.

FIG. 18C illustrates the precursor kernel of FIG. 18B having absorbed a neutron and being converted into an activated material that is a radionuclide of Thulium-170.

FIG. 18D illustrates the activated material of FIG. 18C decaying into a stable decay material and emitting a beta particle that interacts with material around it to produce Bremsstrahlung x-ray radiation.

FIG. 19A illustrates a filling of the CAB unit of FIGS. 10A-B containing precursor material before any charging of the filling.

FIG. 19B illustrates the now charged filling of the CAB unit of FIG. 19A after being exposed to a particle radiation source that is a fission reactor neutron source.

FIG. 19C illustrates the filling of the CAB unit of FIG. 19B during operation, producing beta radiation, which goes onto produce heat that is converted to electricity in the thermoelectric power conversion system of a customer.

FIG. 19D illustrates a depleted filling of the CAB unit of FIG. 19C at the end of operational life.

FIG. 19E illustrates the filling of the CAB unit of FIG. 19D that is now fully depleted.

FIG. 20 is a flowchart of a pre-irradiation encapsulation manufacturing method.

### PARTS LISTING

101 Particle Radiation Source (e.g., Nuclear Reactor Core)

101A-N Particle Radiation Sources

104A-N CAB Units

107 Nuclear Reactor

111A-N Encapsulation Walls

112 Filling

113A-N Exterior Encapsulation Walls

114A-N Interior Encapsulation Walls

150 Encapsulation Matrix

151A-N Precursor Material Particles

152 Encapsulation Material

153 Precursor Kernel

153A-N Precursor Kernels

154 First Precursor Encapsulation Coating

155 Second Precursor Encapsulation Coating

156 Third Precursor Encapsulation Coating

157 Fourth Precursor Encapsulation Coating

158 Precursor Compact

159 Precursor Material

160A-N Subatomic (e.g., Neutron) Particles

161A-N Radiation (e.g., Beta) Particles

162 Activated Material or Radionuclide (e.g., Thulium-170)

163 Decayed Material

164 Interior Volume

190 Chargeable Atomic Battery

191 Chargeable Atomic Battery Housing

192 Chargeable Atomic Battery System

200 CAB Stack

201 Precursor Atom (e.g., Thulium-169)

203 Depleted Atom (e.g., Ytterbium-170)

211 CAB Stack Housing

212 CAB Stack Lid

300 CAB Pack

301 X-Ray Shield

302 Aeroshell

304 Thermal Interface

305 Thermoelectrics

402 Irradiation Capsule

500 CAB Manufacturing Method

505 Radiation Shield

600 Chargeable Atomic Battery Fabrication Method

700 Chargeable Atomic Battery Method

800 Chargeable Atomic Battery Life Cycle Method

801 Type 1 (Wall) Encapsulation

802 Type 2 (Wall and Matrix) Encapsulation

803 Type 3 (Wall, Matrix, and Coating) Encapsulation

805 Type 0: No Encapsulation

900 Precursor Material Performance Chart

959 Precursor Isotope/Atom

962 Activated Isotope/Atom

963 Decayed Isotope/Atom

973A-N Subatomic Decay (e.g., Beta) Particles

974 Subatomic Decay (e.g., Antineutrino) Particles

975 X-Ray Particle

1100 Pre-Irradiation Encapsulation Manufacturing Method

1500 Activation Isotope Production Governing Equations

1600 Reaction Pathway Table

1700 CAB Encapsulation Chart

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “coupled” as used herein refers to any logical, physical, or electrical connection. Unless described otherwise, coupled elements or devices are not necessarily directly connected to one another and may be separated by intermediate components, elements, etc.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The term “approximately,” “significantly,” or “substantially” means that the parameter value or the like varies up to ±25% from the stated amount.

The orientations of the chargeable atomic battery 190, associated components, and/or any chargeable atomic battery system 192 incorporating the chargeable atomic battery 190, CAB units 104A-G, CAB stack 200, CAB pack 300, or precursor material particles 151A-N, such as shown in any of the drawings, are given by way of example only, for illustration and discussion purposes. In operation for a particular chargeable atomic battery 190, the components may be oriented in any other direction suitable to the particular application of the chargeable atomic battery 190, for example upright, sideways, or any other orientation. Also, to the extent used herein, any directional term, such as lateral, longitudinal, up, down, upper, lower, top, bottom, and side, are used by way of example only, and are not limiting as to direction or orientation of any chargeable atomic battery 190 or component of the chargeable atomic battery 190 constructed as otherwise described herein.

The mass number of an element is denoted in two interchangeable formats. In one mass number format, the mass number is appended to the element name or symbol via a hyphen (e.g. Plutonium-238 or Pu-238). In a second mass number format, the mass number prepends the element name or symbol in superscript (e.g. ²³⁸Plutonium or ²³⁸Pu.) Both formats may appear in the same figures and associated detailed description paragraphs, and no special significance should be placed upon the use of a particular mass number format. Mixed mass number formats (e.g. figure elements labeled “Pu-238” with an associated detailed description paragraph reciting “²³⁸Plutonium”) does not indicate a special significance or relationship when compared to non-mixed mass number formats.

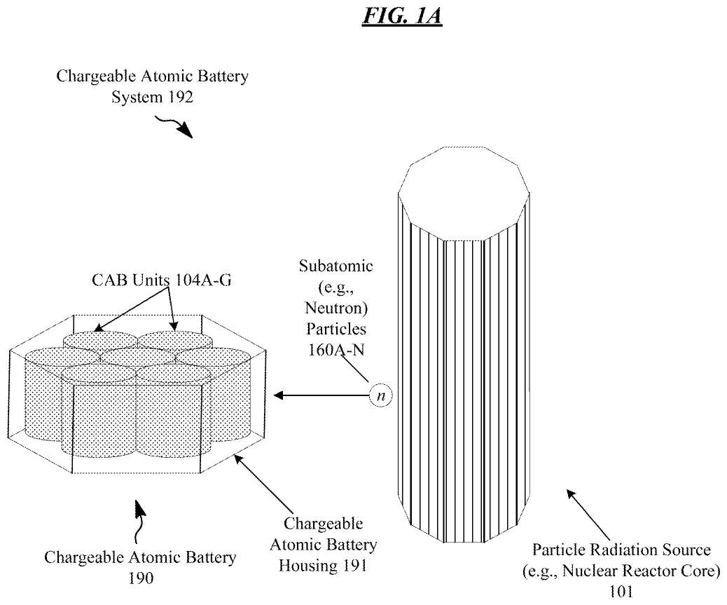

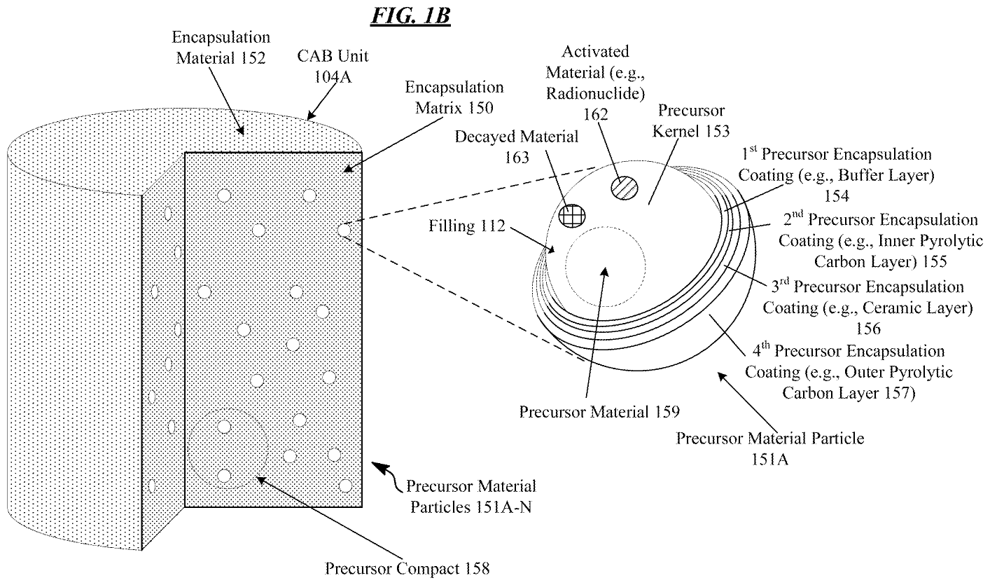

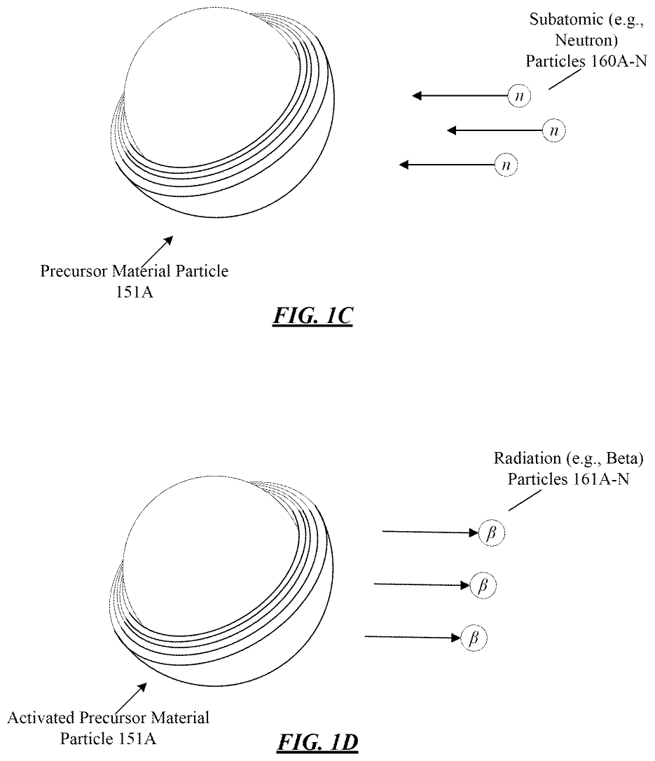

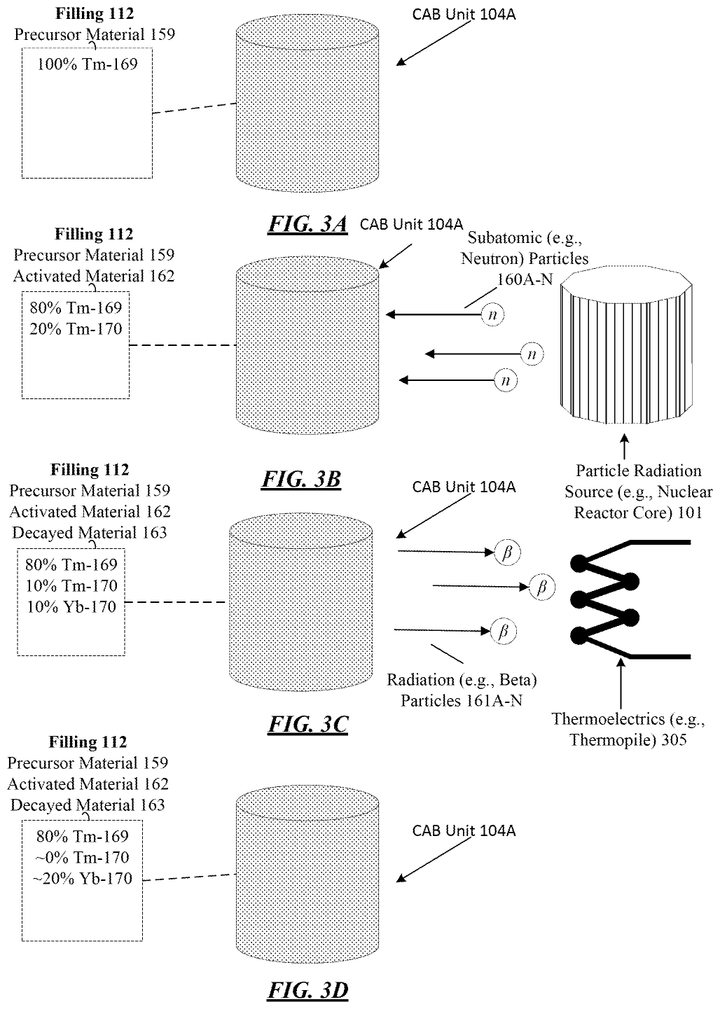

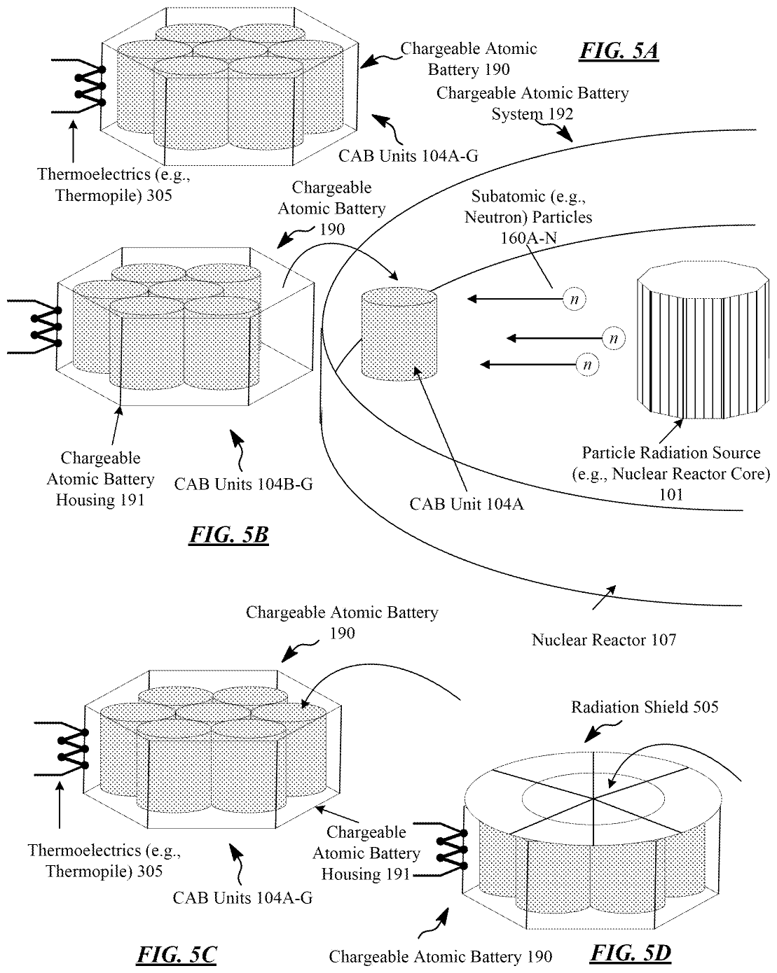

FIG. 1A depicts a chargeable atomic battery system 192 that includes a chargeable atomic battery 190. As shown, chargeable atomic battery 190 includes a plurality of CAB units 104A-G and a chargeable atomic battery housing 191. As shown in the example of FIG. 1A, seven CAB units 104A-G are placed within a chargeable atomic battery housing 191 to hold the CAB units 104A-G. The chargeable atomic battery 191 can enclose or otherwise cover (e.g., partially or fully) the CAB units 104A-G and is selectively openable during: (i) initial charging when the precursor material 159 of the CAB units 104A-G is in a stable state or an unstable state; and (ii) recharging when the precursor material 159 of the CAB units 104A-G is in a partially depleted state and still convertible into an activated state by undergoing irradiation by a particle radiation source 101. The chargeable atomic battery housing 191 is selectively closable when the precursor material 159 of the CAB units 104A-G is charged and in the activated state. The number of CAB units 104A-G of the chargeable atomic battery 190 can vary, e.g., the chargeable atomic battery 190 can include one, two, three, four, five, six, seven, or more CAB units 104A-G. The chargeable atomic battery housing 191 is a structure used to aid in storing, transporting, securing, and retrieving energy from the CAB units 104A-G. Additionally, later figures depict the chargeable atomic battery housing 191 as an appropriate location to attach electrical elements (e.g., thermoelectrics 305 like that shown in FIG. 3) and a radiation shield 505 like that shown in FIG. 5. The radiation shield 505 is a protective covering that can include a rigid heat shield shell to protect from heat, radiation, pressure, etc. In one example, the radiation shield 505 can be formed of an aluminum honeycomb (e.g., hexagonal prismatic walls) shaped structure sandwiched between graphite-epoxy face sheets covered by a layer of phenolic honeycomb (e.g., benzene). The phenolic honeycomb is filled with an ablative material that dissipates heat, such as cork wood, binder and many tiny silica glass spheres. The backshell can be formed like the heat shield, but the backshell may be thinner than the heat shield.

A vehicle (e.g., spacecraft) can include the chargeable atomic battery 190 and an aeroshell attached to the vehicle to protect from heat, radiation, pressure, etc. which can be created by drag during atmospheric entry or reentry of a vehicle. The aeroshell can include the radiation shield 505.

Chargeable atomic battery 190 is placed within range of subatomic particles 160A-N being emitted by a particle radiation source 101. In this example, the particle radiation source 101 is a nuclear reactor core of a nuclear reactor 107 (see FIG. 5B). The chargeable atomic battery 190 is shown next to the nuclear reactor core within a nuclear reactor 107. In the example, the particle radiation source 101 is a nuclear reactor 101 and, as the chargeable atomic battery 190 resides within range of the subatomic particles 160A-N being emitted by the particle radiation source 101, the CAB units 104A-G are bombarded with subatomic particles 160A-N. Alternative particle radiation sources 101A-N can include more generalized fission reactors, fusion reactors, particle accelerators, or other neutron source. A fission reactor splits a heavy nucleus into two or more lighter nuclei, releasing kinetic energy, gamma radiation, and free neutrons. A fusion reactor combines two lighter atomic nuclei to form a heavier nucleus, while releasing energy. A particle accelerator is a machine that uses electromagnetic fields to propel charged particles to very high speeds and energies, and to contain them in well-defined beams.

Chargeable atomic battery housing 191 may induce free neutron 160A-N bombardment (see FIG. 1C), in some examples by being partially lined with a neutron reflector material. Alternatively, the CAB units 104A-G can be removed from the chargeable atomic battery housing 191 to facilitate more direct exposure of the CAB units 104A-G to the subatomic particles 160A-N, or to protect the chargeable atomic battery housing 191 from being unduly exposed to subatomic particles 160A-N from the particle radiation source 101 and potentially experiencing radiation embrittling. As the CAB units 104A-G are exposed to the subatomic particles 160A-N, the precursor material 159 within the precursor material particles 151A-N (see FIG. 1B) is exposed to those same subatomic particles 160A-N (see FIG. 1C). Chargeable atomic battery housing 191 can include a body and lid formed of a non-radioactive material, such as graphite, carbon fiber, carbon bonded carbon fiber, or aluminum.

During an initial charging cycle and a recharge cycle, the chargeable atomic battery 190 is placed inside the particle radiation source 101. As noted above, the particle radiation source 101 can be a nuclear reactor 107, such as a light water nuclear reactor or a heavy water nuclear reactor, which include a nuclear reactor core inside of a pressure vessel. The chargeable atomic battery 190 can be placed in the middle of the pressure vessel (e.g., within the nuclear reactor core) or a reflector region (e.g., an inner reflector region or an outer reflector region) of the pressure vessel. In the light water nuclear reactor, the chargeable atomic battery 190 can be placed in the middle (e.g., center) of the nuclear reactor, for example, the chargeable atomic battery 190 can be interspersed with the CAB units of the nuclear reactor core. In another example, the chargeable atomic battery 190 can be placed within an outer reflector region in a periphery of the pressure vessel during the initial charging cycle and the recharge cycle. An example nuclear reactor 107 suitable as a particle radiation source 101 and that includes a pressure vessel, nuclear reactor core, fuel elements, inner reflector region, and outer reflector region is disclosed in U.S. Patent Pub. No. 2020/0027587, published Jan. 23, 2020, titled “Composite Moderator for Nuclear Reactor Systems,” the entirety of which is incorporated by reference herein.

Unlike a traditional atomic battery, the chargeable atomic battery 190 advantageously does not need to be placed in a hot cell before the initial charging cycle. After the initial charging cycle of the chargeable atomic battery 190, a hot cell can be utilized for examination and handling of the chargeable atomic battery 190 between recharge cycles. However, if a waiting period (e.g., time duration) is selected such that the gap time between recharge cycles is sufficiently long enough to enable radiation decay of the precursor material 159 to a safe level, then the hot cell may not be required for handling of the chargeable atomic battery 190.

A hot cell is a shielded nuclear radiation containment chamber and is separate from the particle radiation source 101. The hot cell can be formed of stainless steel 316, polyvinyl chloride (PVC), Corian®, concrete, etc. The amount and penetrating power of radioactivity present in the radioisotopes of the precursor material 159 prescribe how thick the shielding of the hot cell is. Manipulators, such as a tongs, or a remote manipulator (e.g., telemanipulator), are utilized for the remote handling of the chargeable atomic battery 190 inside of the hot cell during the recharge cycle, if the hot cell is used. The telemanipulator allows an operator to work remotely in a high radiation environment. The telemanipulator is operable to open or close the lid of the chargeable atomic battery 190 to load a subset or all of the CAB units 104A-G after being irradiated in a radiation source 101. The telemanipulator is also operable to unload a subset or all of the CAB units 104A-G for irradiation by the radiation source 101.

Telemanipulator can include a mechanical, electrical, hydraulic control device, or a combination thereof (e.g., electromechanical control device) operable to control the lid (e.g., door) of the chargeable atomic battery 190 after the initial charging cycle or the recharge cycle. In one example, the telemanipulator can include an actuator (e.g., electromechanical actuator) that is operable to enable an operator to open and close the lid by an imparting an open/close signal. After the chargeable atomic battery 190 is placed inside the particle radiation source 101 for irradiation and the initial charging cycle or recharge cycle is actually completed, the chargeable atomic battery 190 is removed from the particle radiation source 101 and then moved to the hot cell. Once the chargeable atomic battery 190 is inside the hot cell, the operator may then utilize the telemanipulator to close the lid of the chargeable atomic battery 190, for example, by sending a close signal via an electromechanical actuator type of telemanipulator. After the chargeable atomic battery 190 is depleted, prior to the recharge cycle the operator may again utilize the telemanipulator prior to a recharge cycle in order to impart an open signal to the chargeable atomic battery 190 that opens the lid prior to placement of the chargeable atomic battery 190 within the particle radiation source 101.

Although the precursor material 159 can be initially manufactured in a stable state and therefore not radioactive immediately after manufacture or an unstable state, after the initial charging cycle a fraction or all of the precursor material 159 is converted into activated material 162, which is radioactive. The hot cell and manipulators can provide safety to a human operator by avoiding exposure to radiation after the initial charging cycle and recharge cycle of the chargeable atomic battery 190 by enabling the lid to be opened or closed remotely. The hot cell and manipulators enable the chargeable atomic battery housing 191 to be openable to uncover the CAB units 104A-F by the operator remotely. Additionally, the chargeable atomic battery housing 191 can be mechanically openable by the operator in a manual manner to uncover the CAB units 104A-G without the hot cell, for example, before the initial charging cycle. The operator can manually open the chargeable atomic battery housing 191 prior to the initial charging cycle or if the gap time between recharge cycles is sufficiently long enough to enable radiation decay of the precursor material 159 to a safe level.

The chargeable atomic battery 190 incorporating the precursor material 159 in the precursor material particles 151A-N can remedy the following deficiencies of traditional atomic batteries. With respect to radiochemistry, manufacturing traditional atomic batteries often requires a significant amount of radiochemical efforts. Traditional materials need to be irradiated and separated in a radiation certified laboratory. Waste products require proper disposal. Some materials, such as Plutonium, are classified as special nuclear materials and require significant security. This complexity drives up cost, especially capital expenditures on facilities which can take many years to make

FIG. 1B is an illustration of a single CAB unit 104A of the chargeable atomic battery 190. Generally, each of the CAB units 104A-G of the chargeable atomic battery 190 are formed of a precursor compact 158 that includes precursor material particles 151A-N embedded inside an encapsulation material 152. In the example, a high-temperature encapsulation matrix 150 is formed of the encapsulation material 152. Hence, the single CAB unit 104A is shown as comprised of precursor material particles 151A-N embedded inside the encapsulation matrix 150 formed of the encapsulation material 152. The encapsulation material 152 can be a high-temperature carbide. Precursor material particles 151A-N can include a precursor kernel 153 surrounded by one or more optional precursor encapsulation coatings 154-157 (e.g., layers). In the example of FIG. 1B, the precursor material particles 151A-N include tristructural-isotropic (TRISO) precursor material particles. Alternatively or additionally, the precursor material particles 151A-N can include bistructural-isotropic (BISO) precursor material particles. TRISO-like coatings may be simplified or eliminated depending on safety implications and manufacturing feasibility. Precursor material particles 151A-N, such as TRISO precursor material particles, are designed to withstand fission product build up inside a nuclear reactor and may not always be beneficial in a radioisotope battery context. Although the precursor material particles 151A-N in the example include coated precursor material particles, such as TRISO precursor material particles or BISO precursor material particles, the precursor material particles 151A-N can include uncoated precursor material particles.

It should be understood that the precursor material 159 does not need to be formed as part of one or more precursor material particles 151A-N embedded inside an encapsulation matrix 150 formed of the encapsulation material 152. As described in International Application No. PCT/US2021/016980, filed on Feb. 7, 2021, titled “Chargeable Atomic Battery with Pre-Activation Encapsulation Manufacturing,” published as WO 2021/159041 on Aug. 12, 2021, the entirety of which is incorporated by reference herein, the precursor material 159 can be in a filling 112 inside an interior volume (e.g., cavity) of the encapsulation material 152. A body that includes one or more encapsulation walls can be formed of the encapsulation material 152. The encapsulation walls include one or more exterior (e.g., outer) encapsulation walls and one or more interior (e.g., inner) encapsulation walls. The interior encapsulation walls interface the filling 112 formed of the precursor material 159 (and activated material 162 if converted into an activated state and/or decayed material 163). Interior encapsulation walls surround an interior volume of the encapsulation material 152 that is filled with or lined with the precursor material 159 (and activated material 162 if converted into the activated state and/or decayed material 163). The optional one or more exterior encapsulation walls and the interior encapsulation walls can be continuous or discontinuous surfaces. The body of encapsulation walls can be circular or oval shaped (e.g., a spheroid, cylinder, tube, or pipe). The body of encapsulation walls can be square or rectangular shaped (e.g., cuboid) or other polygonal shape. The one or more interior encapsulation walls of the encapsulation material 152 can be one continuous interior encapsulation wall surrounding the filling of the precursor material 159 (and activated material 162 if converted into the activated state and/or decayed material 163). Alternatively, the one or more interior encapsulation walls formed of the encapsulation material 152 can be a plurality of discontinuous interior encapsulation walls, which depend on the shape of the filling 112 in the interior volume of the encapsulation material 152. If the filling 112 is a spheroid in three-dimensional space, then there is one continuous interior encapsulation wall of the encapsulation material 152 in the interior volume surrounding the precursor material 159. If the filling 112 is a cuboid or polygonal shape in three-dimensional space, then there are a plurality of continuous interior encapsulation walls of the encapsulation material 152 in the interior volume surrounding the precursor material 159.

Hence, the chargeable atomic battery 190 can include at least one CAB unit 104A formed of a precursor material 159 embedded inside an encapsulation material 152. The chargeable atomic battery 190 further includes a chargeable atomic battery housing 191 to hold the at least one CAB unit 104A. The precursor material 159 can be initially manufactured in a stable state or an unstable state and convertible into an activated material 162 that is an activated state via irradiation by a particle radiation source 101.

On the left side of FIG. 1B, the CAB unit 104A is depicted with a cutaway section of the precursor compact 158 showing the interior of the encapsulation matrix 150, as well as the precursor material particles 151A-N embedded within the encapsulation matrix 150. Although the precursor compact 158 is shown as a cylinder shape in the example, the precursor compact 158 can be formed into a variety of different geometric shapes. For example, the precursor compact 158 can be a tile, e.g., polygonal shape (e.g., cuboid), spheroid, or other shapes that can include a planar surface, an aspherical surface, a spherical surface (e.g., cylinder, conical, quadric surfaces), a combination thereof, or a portion thereof (e.g. a truncated portion thereof). Alternatively or additionally, the precursor compact 158 can include one more freeform surfaces that do not have rigid radial dimensions, unlike regular surfaces, such as a planar, aspherical, or spherical surface. On the right side of FIG. 1B, an individual precursor material particle 151A is depicted at a larger scale in cutaway, to illustrate the components within the precursor material particle 151A.

As an example, the CAB unit 104A can include a plurality of fuel lateral facets that are discontinuous to form an outer periphery of the precursor compact 158. As used herein, “discontinuous” means that the outer periphery formed by the fuel lateral facets in aggregate do not form a continuous round (e.g., circular or oval) perimeter. The outer periphery includes a plurality of planar, aspherical, spherical, or freeform surfaces. As used herein, a “freeform surface” does not have rigid radial dimensions, unlike regular surfaces, such as a planar surface; or an aspherical or spherical surface (e.g., cylinder, conical, quadric surfaces).

The encapsulation material 152 includes silicon carbide, zirconium carbide, titanium carbide, niobium carbide, tungsten, molybdenum, or a combination thereof. Silicon carbide may be advantageous over the other materials to form the encapsulation material 152 because titanium carbide, niobium carbide, tungsten, molybdenum may have too great of activation cross section. Each of the precursor material particles 151A-N can include one more optional precursor encapsulation coatings 154-157 around a filling 112, such as a precursor kernel 153 in the example. In one example, the precursor material particles 151A-N can include the filling 112, shown as a precursor kernel 153, surrounded by a first precursor encapsulation coating (e.g., porous carbon buffer layer) 154, a second precursor encapsulation coating (e.g., an inner pyrolytic carbon layer) 155, a third precursor encapsulation coating (e.g., a ceramic layer) 156, and a fourth precursor encapsulation coating (e.g., an outer pyrolytic carbon layer) 157.

Of the possible encapsulation material 152 within which to embed the precursor material particles 151A-N that form the nuclear fuel tiles 104A-G, silicon carbide (SiC) offers good irradiation behavior, and good fabrication behavior. SiC has excellent oxidation resistance due to rapid formation of a dense, adherent silicon dioxide (SiO₂) surface scale on exposure to air at elevated temperature, which prevents further oxidation.

Hence, the precursor material particles 151A-N can include a precursor kernel 153 coated with one or more layers surrounding one or more isotropic materials. In one example, unlike a conventional TRISO precursor material particle, these precursor material particles 151A-N can be initially manufactured with a radioactively-stable element within a precursor material 159, rather than a radioactive-unstable isotope. For example, rather than having uranium as the core precursor material, the precursor material particles 151A-N can be initially manufactured in a stable state and include stable isotopes as the precursor material 159. For example, the precursor material 159 can include thulium, cobalt, erbium, lutetium, or thallium. Alternatively or additionally, the precursor material 159 can include scandium, silver, hafnium, tantalum, iridium, promethium, europium, gadolinium, and terbium. In another example, the precursor material 159 can include a radioactively-unstable element (e.g., radioactive-unstable isotope), such as Neptunium-237. The precursor material 159 may include unaltered elements, or the elements can be synthesized into a carbide or oxide for chemical stability and immobilized within the encapsulation material 152.

In some examples, such as prior to irradiation, the precursor material particles 151A-N can include a precursor kernel 153 formed of a precursor material 159. Precursor material 159 can include Neptunium-237 (Np-237), Thulium-169 (Tm-169), Europium-151 (Eu-151), Europium-153 (Eu-153), Cobalt-59 (Co-59), etc. and may be formed as a ceramic compound that further includes an oxide, a nitride, a carbide, or a combination thereof.

Precursor encapsulation coatings 154-157 can be a plurality of ceramic coatings, such as graphite, low density graphite, SiC, ZrC, NbC, TiC, TaC, and others. Precursor material particles 151A-N can be embedded in an encapsulation matrix 150, formed of an encapsulation material 152. Encapsulation matrix 150 can include a closed porosity high-temperature matrix. Encapsulation material 152 can include SiC, ZrC, W, Mo, etc. The encapsulation matrix 150 is capable of operating at temperatures above 1,000 degrees Celsius.

The precursor material 159 can be activated in a neutron field for a first period of time. The neutron field is produced by the particle radiation source 101. Activation of the precursor material 159 can include: (a) direct activation of the precursor material 159 as conversion of the stable radioisotope to an unstable radioisotope, or an unstable radioisotope (e.g., Neptunium-237) to another unstable radioisotope (e.g., Plutonium-238) which may be followed by the decay of that radioisotope; (b) production of radioactive fission products and their byproducts if the precursor material 159 undergoes neutron-induced fission; or (c) a combination thereof. Following activation of the precursor material 159, the chargeable atomic battery 190 is stored without material change for a second period of time to allow for potential fission products and undesired material activations to decay to desired levels. The chargeable atomic battery 190 is then incorporated into a system (e.g., radioisotope heat source or radioisotope thermoelectric generator), where the heat produced by the radio-active material is used without material change to the chargeable atomic battery 190. The chargeable atomic battery 190 can also be used for the safe transmutation of transuranic material and nuclear waste from a nuclear reactor 107. For example, the transuranic material or nuclear waste (e.g., Neptunium-237) from the nuclear reactor 107 can be used to form the precursor material 159.

Additionally, any isotope capable of interacting with external radiation through reaction pathways, such as absorbing external neutrons, which is then capable of emitting latent radiation into a stable state (which generally means the precursor material 159 then has a stable isotope) may be selected. The isotope can be part of an element, which may be part of a carbide, oxide or molecule that is selected during manufacturing the precursor material 159 is in a stable state or an unstable state, but the selection is convertible into an activated state, generally as an activated material 162 via irradiation by some particle radiation source 101. The activated material 162 is a radionuclide, also referred to as a radioactive nuclide, radioactive isotope, or a radioisotope. The precursor material 159 forming the CAB unit 104A is held among the plurality of CAB units 104A-G in the chargeable atomic battery housing 191.

Additionally, the element, carbide, oxide, or molecule can be selected based on a mission duration of the entire chargeable atomic battery 190. Generally, the half-life of the selected activated material 162 can be approximately as long as the mission duration: this will ensure consistent energy emissions during the entire mission, and generally the precursor material 159 under consideration when activated have half-lives in the range of 100 days to 1,200 years and can be catered to the performance needs of the customer. As used herein, half-life means the time duration that half of the unstable atoms in the activated state undergo radioactive decay.

The mission duration is the length of time required to complete an assignment for which the chargeable atomic battery 190 is purpose-built to complete. For example, the mission duration of the Curiosity Mars Rover was 23 months upon reaching the surface of Mars. Because the chargeable atomic battery 190 emits radiation constantly once activated until depleted, the mission duration can be calculated from the date that activation of the precursor material 159 is completed. Continuing with the Curiosity Mars Rover example, had the Mars Rover been equipped with a chargeable atomic battery 190, the mission of the chargeable atomic battery 190 would be to provide power to the Mars Rover until the mission of the Mars Rover is completed. The required mission duration would have been at minimum 31 months: 23 months to complete the mission of the Mars Rover upon Mars, and an additional eight months during which the Mars Rover, equipped with the activated chargeable atomic battery 190, travels from Earth to Mars. Further, if the chargeable atomic battery 190 was scheduled to wait six months after activation before being launched with the Mars Rover from Earth, the mission duration would have been at minimum 37 months.

To improve neutron absorption, the selected precursor material 159 can have a large enough neutron absorption cross section to stimulate a reaction but small enough to prevent self-shielding. A cross section is between 15 barns to 120 barns will have good performance, and a cross section between 25 barns to 60 barns can be ideal. Materials with a lower thermal cross section absorption can be very effective, such as Cobalt, with a thermal neutron absorption cross section of 37 barns. However, there are many exceptions to this rule. Europium (e.g., Europium-170) and Lithium, for example, have much larger cross sections (1,000+barns) and can perform well. If the thermal neutron cross section of the activated material 162 is too large, the precursor material 159 may transmute into another radionuclide typically with a mismatched half-life. This transmutation is known as double activation, and is usually undesirable as it reduces the amount of the desired radioisotope and introduces a new isotope typically with a half-life that is much shorter or much longer than desired. However, Europium and Lithium, for example, have much larger cross sections and can perform well in some examples. Depending on the level of self-shielding, a precursor geometry of the precursor material 159 can be tailored to maximize activation or power density. For example, Europium and Lithium, which have large neutron absorption cross sections can be made as thin as necessary to account for self-shielding.

The selected precursor material 159 can be sintered during manufacturing, and therefore a good precursor material 159 withstands a temperature of at least 1,500 Kelvin without undergoing melting during the sintering: this ensures the precursor material 159 can remain in the stable state, but may also be in an unstable state. In terms of operating temperature, the chargeable atomic battery 190 examples can be utilized over a wide range of temperatures—from well below freezing up to and exceeding 1000 Kelvin (726 degrees C. or 1340 degrees F.).

The precursor material 159 selected preferably benefits from being relatively abundant: Some natural elements have several isotopes each with their own cross section and activation isotopes. The precursor material 159 should be relatively easy to work with in terms of its chemical toxicity. Furthermore, the total mass of the precursor material 159 can be relatively small compared to the total mass of the precursor compact 158. In an example, depending on the isotope, the mass of the precursor material 159 can be one-percent (1%) or less of the mass of the precursor compact 158 within the CAB unit 104A. Some precursor materials 159 can be enriched to improve performance. All precursor compacts 158 presented here use natural non-isotopically enriched precursor material 159. However, isotopically enriched precursor materials can be used to obtain a higher concentration of the desired activated isotope. Later figures will demonstrate how the precursor material 159 is converted from a radioactively stable state or an unstable state to a neutron-emitting radioactive state that is an activated material 162.

When the precursor material particles 151A-N are implemented as TRISO precursor material particles, the TRISO precursor material particles 151A-N include four precursor encapsulation coatings (e.g., layers) of three isotropic materials. For example, the four precursor encapsulation coatings can include: (1) a porous buffer layer 154 made of carbon; followed by (2) a dense inner pyrolytic carbon (PyC) layer 155; followed by (3) a binary carbide layer (e.g., ceramic layer 156 of SiC or a refractory metal carbide layer) to retain fission products at elevated temperatures and to give the TRISO precursor material particles 151A-N a strong structural integrity; followed by (4) a dense outer PyC layer 157. The refractory metal carbide layer of the TRISO precursor material particles 151A-N can include at least one of titanium carbide (TiC), zirconium carbide (ZrC), niobium carbide (NbC), tantalum carbide, hafnium carbide, ZrC-ZrB₂ composite, ZrC-ZrB2-SiC composite, or a combination thereof. The encapsulation material 152 can be formed of the same material as the binary carbide layer of the TRISO precursor material particles 151A-N.

TRISO precursor material particles 151A-N are designed not to crack due to the stresses or fission gas pressure at temperatures beyond 1,600° C., and therefore can contain the precursor kernel 153 formed of the precursor material 159 in the worst of accident scenarios. TRISO precursor material particles 151A-N are designed for use in high-temperature gas-cooled reactors (HTGR) that include the particle radiation source 101 as a nuclear reactor core and to be operating at temperatures much higher than the temperatures of LWRs. TRISO precursor material particles 151A-N have extremely low failure below 1500° C. Moreover, the presence of the encapsulation material 152 provides an additional robust barrier to radioactive product release.

The encapsulation material 152, and any precursor encapsulation coatings 154-157 of the precursor material particle 151A may all be composed of different chemical compounds. But those chemical compounds should satisfy one or more of the following criteria: high temperature capability; chemical non-reactivity during manufacturing, charging, or operation; mechanical strength; crack propagation resistance; diffusion or other means of radionuclide transfer through grains on grain boundaries resistance; significant degradation of material properties during irradiation or charging resistance; favorable thermodynamic properties (such as thermal conductivity); or a low nuclear activation cross section. These criteria are not exhaustive, and there may be other criteria depending on the application of the chargeable atomic battery 190.

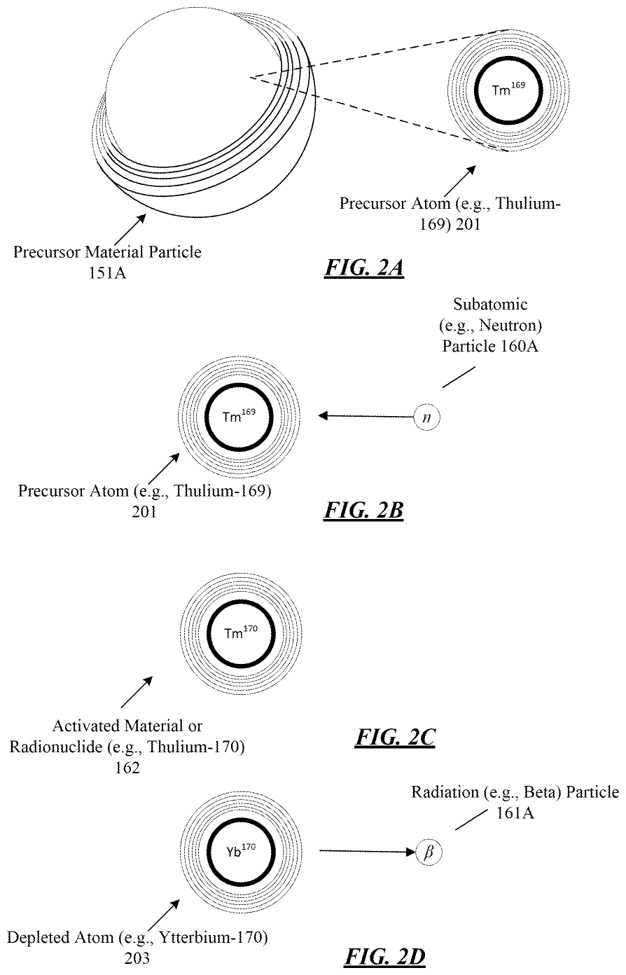

The particle radiation source 101 can be implemented like the nuclear reactor core described in FIG. 2C and the associated text of U.S. Patent Pub. No. 2020/0027587 to Ultra Safe Nuclear Corporation of Seattle, Wash., published Jan. 23, 2020, titled “Composite Moderator for Nuclear Reactor Systems,” the entirety of which is incorporated by reference herein.

Alternatively, the particle radiation source 101 can be a fission reactor: currently available fission reactors can provide high fluxes of neutrons in thermal (energies around 0.253 eV) and to a lesser degree at higher energies up to 20 MeV. HFIR and ATR have produced isotopes such as Pu-238. For nuclear reactions that can be driven by low energy neutrons, fission reactors are excellent choices. Fusion reactors are also contemplated: while not break even in terms of their energy gain, the currently available D-T fusion reactors nevertheless can provide 14.1 MeV neutrons at a moderate flux. In some cases, fusion and fission can be combined into a hybrid reactor to provide a higher neutron flux. Additionally, accelerators are a well-known technology capable of accelerating charged particles to an incredibly high energy. Accelerators can provide a wide range of energies and can provide a beam energy tailored to the correct activation energy of the reaction desired. Accelerated protons, deuterons, and alpha particles can be used directly to produce many radionuclides. Accelerated electrons can produce predictable and controllable level of x-ray photons through Bremsstrahlung. These photons reactions can then be used to drive nuclear reactions and produce nuclear battery materials. Accelerators are very flexible, but usually suffer from low flux. However, recent advances in accelerator technology from demand in the medial radioisotope industry have yielded potential production methods for significant quantities of radioisotopes.

FIG. 1C depicts an individual precursor material particles 151A being exposed to subatomic particles 160A-N. The subatomic particles 160A-N pass into the precursor compact 158, through the encapsulation material 152, and any outer precursor encapsulation coatings 154-157 of the precursor material particle 151A, striking the precursor material 159. The precursor material 159, having been selected to absorb subatomic particles 160A-N, absorbs some or all of the subatomic particles 160A-N and a portion of the precursor material 159 becomes activated, and radioactive. Not all of the free neutrons emitted by the particle radiation source 101 will irradiate the precursor material 159: some may be blocked, deflected, or absorbed by other materials within the precursor compact 158. The CAB units 104A-G are designed to be placed completely within the radiation range of the particle radiation source 101: the precursor material particle 151A and the precursor material 159 are not separated from the encapsulation material 152, the precursor compact 158, or the CAB unit 104A-G during this radiation exposure process. This bombardment of subatomic particles 160A-N into the precursor material 159 is a charge cycle: the charge cycle can last a variable amount of time, for example one month. The CAB units 104A-G can be charged for multiple cycles or in a higher radiation flux for higher performance levels. In this example, a charge cycle is defined as a one-month irradiation in a typical megawatt scale reactor. The chargeable atomic battery 190 can be charged for multiple cycles or in a higher radiation flux for higher performance levels.

The first time the precursor material 159 is charged of a CAB unit 104A is an initial charging cycle: the particle radiation source 101 converts an initial portion of the precursor material 159 into the activated, radiation-emitting state. Prior to the initial charging cycle, the precursor material 159 is not a radioactive material, which simplifies handling of the chargeable atomic battery 190 in both the supply chain and distribution chain. Because the precursor material 159 is not radioactive prior to the initial charging cycle, applicable government regulations regarding handling, storage, etc. of the chargeable atomic battery 190 are reduced. The portion converted is not easily ascertainable by an observer: subatomic particles 160A-N pass through the precursor compact 158 until they strike an element, ideally one within the precursor material 159. Therefore, the CAB unit 104A does not charge top-to-bottom, front-to-back, or inside-to-outside. The entire CAB unit 104A has a percentage of the precursor material particles 151A-N and accompanying precursor material 159 that are activated and converted into activated material 162, and a percentage of the precursor material particles 151A-N and accompanying precursor material 159 that are stable. Typically, the activated portions and the stable portions cannot be meaningfully identified, segregated, or separated. Moreover, the activated material 162 in the precursor kernel 153 ultimately radioactively decays into a decayed material 163.

Successive chargings of the CAB unit 104A are recharge cycles. In the recharge cycles, the particle radiation source 101 converts a recharge portion of the precursor material 159 into the activated, radiation-emitting state. This recharge portion is separate from the initial portion. The recharge cycle can only irradiate portions of the precursor material 159 that have never been activated: should all of the precursor material 159 within all of the precursor material particles 151A-N in a CAB unit 104A be completely charged then depleted. Then the CAB unit 104A is fully depleted and cannot be recharged again.

Different implementations of the particle radiation source 101 may use varying reaction pathways to irradiate the chargeable atomic battery 190, such as neutron reactions, proton/ion reactions, photon reactions, fission. Neutron activation is the reaction pathway process of a nuclide absorbing a neutron and becoming radioactive (n,y). There are other reactions such as a (n,2n) or (n,p). The precursor atom 201 in FIG. 2A is an example of the nuclide, and an activated material 162 in FIG. 2C is an example of a nuclide becoming radioactive (radionuclide). Low energy neutrons (0-1 MeV) can be produced in high flux fission reactors and higher energy neutrons can be produced by fusion (<14.1 MeV) or using accelerators, which can produce a very high energy tailored neutron spectrum albeit at a lower flux level. Additionally, high energy proton, deuteron, and alpha particle reactions can interact with a nucleus of a precursor atom 201 to create radioisotopes through absorption, spallation, or other means. Further, photonuclear reactions provide another set of possible atomic reactions that can produce new radioisotopes within the precursor material 159. Recent advances in electron accelerators can produce high-flux high-energy gamma environments through Bremsstrahlung radiation. Several methods for producing medical isotopes have been shown using this method. Still further, a fission reaction produces two radioisotopes. The exact radioisotope produced is dependent upon the nuclide being fissioned and the incident neutron energy. The exact radioisotope product can also be stochastic. That is, there is a distribution of fission product yields for a given nuclide and incident neutron energy. There are many heavy nuclei, which are fissionable and will produce a different set of radioisotopes, providing many potential options for radioisotope production.

FIG. 1D depicts the individual precursor material particle 151A from FIG. 1C, now having been exposed to subatomic particles 160A-N and having become irradiated to become an activated precursor material particle 151A. Once irradiated, the activated material 162 within the precursor material particle 151A emits radiation particles 161A-N. In this example, the precursor material particle 151A emits beta particles, but alpha particles, gamma particles, and x-rays may all be emitted, depending on which element or molecule is selected for the precursor material 159. Some radiation particles 161A-N (alpha, beta, gamma, x-ray) may be preferred depending on the deployment of the chargeable atomic battery 190. Selecting different activated materials 162 allows for customization of a power format and half-life duration from a wide range of alpha-emitting, beta-emitting, and gamma-emitting radioisotopes that a given precursor material 159 is transformed into when activated.

The radiation particles 161A-N travel away from the CAB unit 104A: by some energy conversion means, either via thermoelectrics 305, Stirling power converters, coolant heating, or nuclear pulse propulsion. These radiation particles 161A-N impart thermal, electrical, or impulse force onto an external system requiring energy, such as satellites, lunar electronics, underwater vehicles, or remote heating devices. Depending on the tolerance for radiation of these energy conversion means and any coupled electronic components, the mass of any radiation shield 505 such as in FIG. 5 required may be greater. A conservative estimate for the tolerance of the electronics is 25 kilorads (krad) in Silicon. Some electronics can tolerate dose levels in the millirad (mrad) range. Techniques such as moving the electronics further from the CAB unit 104A may help reduce required radiation shield 505 mass.

Therefore, FIG. 1A depicts a chargeable atomic battery 190 comprising a plurality of CAB units 104A-G. Each of the CAB units is formed of a precursor compact 158 that includes precursor material particles 151A-N embedded inside an encapsulation material 152. The precursor material particles 151A-N include a precursor kernel 153 formed of a precursor material 159 that can be initially manufactured in a stable state or an unstable state and convertible into an activated material 162 that is an activated state via irradiation by a particle radiation source 101. The chargeable atomic battery 190 further comprises a chargeable atomic battery housing 191 to hold the plurality of CAB units 104A-G.

Upon the precursor material 159 being converted, the precursor material 159 is in a partially depleted state such that an initial portion of the precursor material 159 is depleted and a recharge portion of the precursor material 159 is convertible into the activated state via irradiation by the particle radiation source 101 for recharging the chargeable atomic battery 190. During an initial charging cycle, the particle radiation source 101 converts the initial portion of the precursor material 159 into the activated state. During a recharge cycle of the chargeable atomic battery 190, the particle radiation source 101 converts the recharge portion of the precursor material 159 that is different from the initial portion into the activated state. After the initial charging cycle, the activated material 162 has a half-life approximately as long as a mission duration of the chargeable atomic battery 190. The stable state of the chargeable atomic battery 190 is a stable isotope, and the activated state is a radionuclide.

Within the chargeable atomic battery 190, in the stable state or the partially depleted state, the precursor material 159 can include a thermal neutron absorption cross section between 15 to 120 barns, and the precursor material 159 further includes an oxide, a nitride, a carbide, or a combination thereof. In another example, the precursor material 159 can include a thermal neutron absorption cross section of at least 10 barns. In yet another example, the precursor material 159 can include a thermal neutron absorption cross section of at least 50 barns. Additionally, the precursor material 159 withstands a temperature of at least 1,500 Kelvin without undergoing melting during sintering.

The particle radiation source 101 emits subatomic particles 160A-N, and the subatomic particles 160A-N include neutrons, protons, deuterons, alpha particles, high-flux high-energy gamma particles, a fissile atom, or a combination thereof. A chargeable atomic battery system 192 includes the chargeable atomic battery 190 and the particle radiation source 101. The chargeable atomic battery 190 is placed in proximity to the particle radiation source 101, and the particle radiation source 101 converts the precursor material 159 into the activated material 162 while the plurality of CAB units 104A-G are exposed to the subatomic particles 160A-N within the particle radiation source 101. The particle radiation source 101 includes a nuclear reactor 107 such as in FIG. 5. Hence, the chargeable atomic battery 190 is placed within the nuclear reactor 107, and the nuclear reactor 107 converts a portion of the precursor material 159 into the activated state while the plurality of CAB units 104A-G are placed within the nuclear reactor 107. The activated state is a radioisotope. The particle radiation source 101 converts the precursor material 159 into the activated material 162 based on a reaction pathway, and the reaction pathway is neutron activation induced by spallation. The chargeable atomic battery housing 191, radiation shield 505, etc. can be removable components to enable the CAB units 104A-G alone to be placed in the nuclear reactor 107 during an initial charging cycle or a recharge cycle.

The precursor material 159 can be a radioactively-stable nuclide, and in some examples, in the stable state the precursor material 159 includes Thulium-169 (¹⁶⁹Tm). In the activated state, the precursor material 159 is converted into an activated material 162. The activated material 162 includes Thulium-170 (¹⁷⁰Tm). In the activated state, the precursor material 159 can include an alpha emitting isotope, a beta emitting isotope, a gamma emitting isotope, or a combination thereof. The alpha, beta, or gamma emitting isotopes emit the radiation particles 161A-N. In an example, a precursor material mass of the filling 112 of the precursor material 159, activated material 162, and decayed material 163 can be one-percent (1%) or less of an overall mass of the precursor compact 158. The encapsulation material 152 of the chargeable atomic battery 190 can include silicon carbide, zirconium carbide, titanium carbide, niobium carbide, tungsten, molybdenum, or a combination thereof.

FIG. 2A is a depiction of a precursor material particle 151A with detail on a single precursor atom 201 of the precursor material 159. There are multiple similar precursor atoms 201 within the precursor material 159 all behaving similarly, but the behavior of a single precursor atom 201 is shown for illustrative purposes. In this example, the precursor material 159 is Thulium, and so the precursor atom 201 of the precursor material 159 is an atom of Thulium. Thulium-169 is a stable isotope of Thulium, and therefore precursor material 159 made of Thulium-169 is in the stable state, is not radioactive, does not emit radiation particles 161A-N, energy, or force, and can be safely handled and stored. Thulium is an exemplar element, and a variety of elements and molecules can be used in the chargeable atomic battery 190 and will behave in a similar manner with respect to the features emphasized in FIG. 2.

FIG. 2B depicts one of the subatomic particles 160A of the subatomic particles 160A-N in FIG. 1C bombarding the particular precursor atom 201 of Thulium-169. The subatomic particle 160A is a neutron emitted from the particle radiation source 101, and upon striking the precursor atom 201, the subatomic particle 160A joins the nucleus of the precursor atom 201, converting the precursor atom 201 from Thulium-169 to Thulium-170. Thulium-170 is a radioisotope or radionuclide, and has one more neutron than Thulium-169. The precursor atom 201, now transformed into the activated material (radionuclide) 162 at some point will emit radiation as projected based upon the half-life of the activated material 162 of Thulium-170. When the chargeable atomic battery 190 has a substantive amount of Thulium-170 within the precursor material particle 151A, the chargeable atomic battery 190 will create enough energy to provide external power to a coupled system, for example a thermoelectrics 305 like in FIG. 3. Thermoelectrics 305 can include a thermopile, which is an electronic device that converts thermal energy into electrical energy and that includes several thermocouples as an array connected usually in series or, less commonly, in parallel. Thermoelectrics 305 can include heavily doped semiconductors: semiconductors, which have so many free electrons that they have many properties that can generate electricity from the application of a temperature gradient, or vice versa, through the thermoelectric effect. For example, thermoelectrics 305 can include thermoelectric generators, which are solid-state devices that convert heat directly to electricity.

By exploiting this coupling between thermal and electrical properties, thermoelectrics 305 generate electricity from heat flows. A thermoelectric device creates a voltage when there is a different temperature on each side. At the atomic scale, an applied temperature gradient causes charge carriers in the material to diffuse from the hot side to the cold side to generate electricity.

FIG. 2C shows the precursor atom 201 as the activated material (radionuclide) 162 that the precursor atom 201 was converted into. The precursor atom 201 was Thulium-169, and upon absorbing the subatomic particle 160A the precursor atom 201 converted into the activated material 162, a Thulium-170 isotope. In this state, the activated material 162 will eventually emit radiation, and therefore energy, outside of its nucleus.

FIG. 2D shows the activated material (radionuclide) 162 after the activated material 162 has emitted a radiation particle 161A: in this example, Thulium-170 emits primarily beta radiation, so the activated material 162 emits a fast moving electron as the primary radiation particle 161A. Upon the activated material 162 emitting the radiation particle 161A, the activated material 162 changes into a depleted atom 203 of decayed material 163. The depleted atom in this example is decayed material 163 of Ytterbium-170 (¹⁷⁰Yb), which has the same number of neutrons as Thulium-170, and the same number of electrons as Thulium-169. Ytterbium-170 (¹⁷⁰Yb) is a stable isotope of Ytterbium, and will no longer emit radiation. Additionally, the decayed material 163 of Ytterbium-170 cannot be recharged at the particle radiation source 101, and therefore once the filling 112 of the precursor material particles 151A-N are substantially filled with decayed material 163, the CAB unit 104A can no longer be recharged.

FIG. 3A depicts the initial charging process at the CAB unit 104A level. FIG. 3A shows the CAB unit 104A after initial manufacture. The label illustrates that the filling 112 within the precursor material particles 151A-N of the CAB unit 104A are at this time 100% of the precursor material 159 (Thulium-169). This means that the CAB unit 104A is not radioactive, but can be made radioactive by the particle radiation source 101.

FIG. 3B shows the CAB unit 104A near the particle radiation source 101, being bombarded by the subatomic particles 160A-N. As shown, during the initial charging cycle, the filling 112 makeup has changed from 100% precursor material 159 (Thulium-169), to 80% precursor material 159 (Thulium-169), and 20% activated material 162 (Thulium-170).

FIG. 3C illustrates the CAB unit 104A emitting radiation particles 161A-N, in particular at thermoelectrics 305, and with further particularity at a thermopile, for example. Therefore, the chargeable atomic battery 190 further comprises thermoelectrics 305 coupled to the CAB unit 104A to convert radioactive emissions of an activated material 162, such as the radiation particles 161A-N, into electrical power; the thermoelectrics 305 adjust output of the electrical power. That way, any electrical system coupled to the thermoelectrics 305 receives uniform electrical output during the mission duration of the chargeable atomic battery 190. In FIG. 3C, the filling 112 makeup has changed to 80% precursor material 159 (Thulium-169), and 10% activated material 162 (Thulium-170), and 10% decayed material 163 (Yb-170).

FIG. 3D describes the CAB unit 104A after the mission duration has elapsed. The activated material 162 of Tm-170 is significantly depleted into approximately 20% decayed material 163 of Yb-170 now, and the entire CAB unit 104A is in a reduced charge state. There is residual radioactivity based on the half-life. After 10-20 half-lives the activated material 162 would be negligible and the battery would be depleted, which would be much longer than the mission duration. However, initially the stable state was 100% precursor material 159 (Thulium-169), whereas now the filling 112 after 10-20 half-lives is approximately 80% precursor material 159 (Thulium-169) and approximately 20% decayed material 163 (Ytterbium-170). In this state, 20% of the permanent capacity of the CAB unit 104A has been used and the precursor material 159 is 20% partially depleted. However, the chargeable atomic battery 190 still includes 80% of the precursor material 159 (Thulium-169) remaining that can still be activated during recharging.

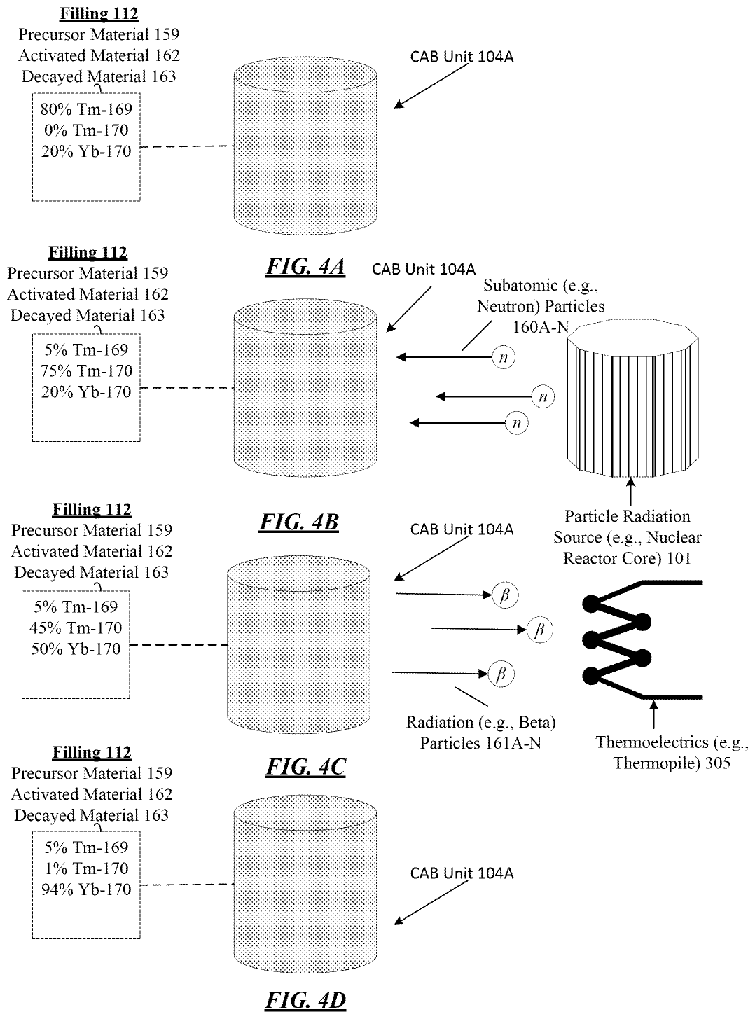

FIG. 4 depicts the recharging process at the CAB unit 104A level. FIG. 4A shows the CAB unit 104A after the effects of FIG. 3D: The labeling illustrates where the filling 112 within the precursor material particles 151A-N of the CAB unit 104A is positioned; this time possessing 80% precursor material 159 (Thulium-169) and 20% decayed material 163 (Ytterbium-170). This means that the CAB unit 104A is not radioactive (after 10-20 half-lives), but can be made radioactive by the particle radiation source 101. The CAB unit 104A can also be placed in the particle radiation source 101 before it is fully depleted (less than 10-20 half-lives) bit will contain some amount of residual radioactivity.

FIG. 4B shows the CAB unit 104A near the particle radiation source 101, being bombarded by the subatomic particles 160A-N. During the recharge cycle, the filling 112 makeup has changed from 80% precursor material 159 (Thulium-169) and decayed material 163 (20% Ytterbium-170), to 5% precursor material 159 (Thulium-169), 75% activated material 162 (Thulium-170), and 20% decayed material 163 (Ytterbium-170).

FIG. 4C illustrates the CAB unit 104A emitting radiation particles 161A-N, in particular at thermoelectrics 305, and with further particularity at a thermopile, for example. As the CAB unit 104A emits radiation particles 161A, the amount of activated material 162 (Thulium-170) decreases and the amount of decayed material 163 (Ytterbium-170) increases at the same rate: at the time of FIG. 3C, there is still 45% activated material 162 (Thulium-170) and 50% decayed material 163 (Ytterbium-170) within the CAB unit 104A. In some examples, this can indicate the chargeable atomic battery 190 is approximately halfway through the full lifespan of the chargeable atomic battery 190. However, as the precursor material 159 is depleted, the precursor material 159 does not charge as well because there are not as many atoms present. A limiting factor can be the mechanical integrity of the chargeable atomic battery 190, which degrades with irradiation.

FIG. 4D describes the CAB unit 104A after the mission duration has elapsed: the activated material 162 is depleted now, and the entire CAB unit 104A is in a stable state. However, the filling 112 is 5% precursor material 159 (Thulium-169), 1% activated material 162 (Thulium-170), and 94% decayed material 163 (Ytterbium-170). Even though the chargeable atomic battery 190 is still slightly radioactive, and has a small amount of precursor material 159 that may be irradiated, the chargeable atomic battery 190 may nevertheless be retired. The entire chargeable atomic battery 190 does not need to be fully depleted before retiring, and in practical use scenarios the chargeable atomic battery 190 is unlikely to be completely used up.

FIG. 5A depicts the charging process of a chargeable atomic battery 190 with a chargeable atomic battery housing 191 capable of decoupling the CAB units 104A-G. FIG. 5A shows the chargeable atomic battery 190 with multiple CAB units 104A-G coupled to thermoelectrics 305. CAB unit 104A is depleted and requires recharging.

FIG. 5B shows the single CAB unit 104A being removed from the chargeable atomic battery housing 191 and being placed within the nuclear reactor 107 near the particle radiation source 101 of the chargeable atomic battery system 192. As shown in FIG. 4B, the single CAB unit 104A is bombarded by subatomic particles 160A-N, which are neutrons emitted by the nuclear reactor core acting as the particle radiation source 101. The chargeable atomic battery housing 191 may not be suited to holding the CAB unit 104A while the CAB unit 104A is charging. This may be due to the thermoelectric 305 having sensitivity to radiation from the particle radiation source 101, or due to the chargeable atomic battery housing 191 having a radiation shield 505. The radiation shield 505 can prevent the CAB units 104A-G from exposing nearby objects to radiation, but that same radiation shield 505 would likely inhibit the subatomic particles from the particle radiation source 101 from reaching the CAB unit 104A efficiently. The radiation shield 505 can be implemented using a high-density material, which is optimal for blocking x-ray radiation. Such materials can include Tungsten and natural or depleted Uranium. For applications where low mass is not a priority, other materials can be used. These shields can be roughly spherical with a cavity for the CAB units 104A-G to be placed inside, for example, in the center.

FIG. 5C illustrates the CAB unit 104A being returned to the chargeable atomic battery housing 191 and thereby the chargeable atomic battery 190. Now, the chargeable atomic battery 190 has the benefit of the recharged CAB unit 104A, without requiring direct exposure to the particle radiation source 101.

FIG. 5D describes placing a radiation shield 505 on the chargeable atomic battery 190. In spaceflight deployments, the spacecraft can include an aeroshell to keep the CAB units 104A-G from being released upon accidental atmospheric reentry during an event such as a rocket launch failure. In some cases, the aeroshell can further protect the spacecraft during atmospheric entry. Such an aeroshell can include the radiation shield 505, protecting any persons or equipment from radiation emitted by the chargeable atomic battery 190. In other examples, the radiation shield 505 may not be as purpose-built as a radioactivity-shielding aeroshell, and may just act as a radiation shield 505 formed as a cladding that encases the plurality of CAB units 104A-G, particularly if the precursor material 159 emits X-rays. In some cases, the aeroshell can serve as additional radiation shielding reducing or eliminating the main radiation shield 505.

Some chargeable atomic batteries 190 emit x-ray or gamma ray radiation, which requires a radiation shield 505. For other types of chargeable atomic batteries 190, no shield is required. Precursor materials 159 that require shielding have higher performance at higher power levels. As noted above, for space applications the radiation shield 505 can double as the aeroshell. For chargeable atomic batteries 190, which require shielding, two dose levels were evaluated: (a) 5 millirem per hour (mrem/hour); and (b) 100 mrem/hour. The 5 mrem/hr dose rate is below the NRC definition of a radiation area and is similar to the dose on the ISS. The 100 mrem/hour dose level is below the NRC definition of a high radiation area with controlled access but would be suitable for contact with electronics and would be accessible to technicians for hour-long periods. For some applications (such as in space) a directional shield can be used to greatly reduce the mass of the shield.

Chargeable atomic batteries 190 with a strong x-ray source can utilize x-ray fluorescence for remote sensing or other applications where radiation can be useful. Additionally, in such chargeable atomic batteries 190 the integral design of the chargeable atomic battery 190 with a radiation shield 505 can enable high flux, well-collimated particle sources. In an example, a vehicle comprises the chargeable atomic battery 190 and an aeroshell. The aeroshell includes the radiation shield 505.

FIG. 6 is a flowchart depicting a chargeable atomic battery fabrication method 600 for manufacturing a chargeable atomic battery 190. In step 605, the chargeable atomic battery fabrication method 600 includes providing a plurality of precursor material particles 151A-N. The precursor material particles 151A-N include a filling 112 (e.g., precursor kernel 153) formed of a precursor material 159 that is initially manufactured in a stable state or an unstable state and convertible into an activated material 162 that is an activated state via irradiation by a particle radiation source 101. In this step 605, and while in the stable state, the precursor material 159 is a radioactively-stable nuclide, and is Thulium-169 — once activated, in the activated state, the precursor material 159 is converted into the activated material 162. The activated material 162 includes Thulium-170. The precursor material particles 151A-N include tristructural-isotropic (TRISO) precursor material particles or bistructural-isotropic (BISO) precursor material particles.

Chargeable atomic battery fabrication method 600 further comprises mixing the plurality of precursor material particles 151A-N with ceramic power to form a mixture in step 610. The ceramic powder is the material that forms the encapsulation material 152, and the mixture is the precursor compact 158. The encapsulation material 152 can include silicon carbide, zirconium carbide, titanium carbide, niobium carbide, tungsten, molybdenum, or a combination thereof, and therefore so does the ceramic powder.

In step 615, the chargeable atomic battery fabrication method 600 includes placing the mixture in a die. The die forms the mixture that is the raw precursor compact 158 into the desired shape of the final CAB unit 104A. The mass of the precursor material 159 can be as little as 1% or less of the mass of the overall mixture constituting the raw precursor compact 158. At any point prior to the step of packaging the plurality of CAB units 104A-G in the chargeable atomic battery housing 191, selecting the activated material 162 with a half-life approximately as long as a mission duration of the chargeable atomic battery 190 the CAB unit 104A will eventually be formed into may be performed. This selection can be performed if a particular chargeable atomic battery 190 and mission duration are known. Additionally, prior to the step 605 of providing the plurality of precursor material particles 151A-N, the chargeable atomic battery fabrication method 600 can include selecting the precursor material 159 such that, in the stable state, the precursor material 159 can have a thermal neutron absorption cross section between 15 and 120 barns. In another example, the precursor material 159 has a thermal neutron absorption cross section of at least 10 barns (e.g., Cobalt is 37 barns). In yet another example, the precursor material 159 has a thermal neutron absorption cross section of at least 50 barns. Further, prior to the step 605 of providing the plurality of precursor material particles 605, selecting the precursor material 159 can include selecting an oxide, a nitride, a carbide, or a combination thereof.

In step 616, the chargeable atomic battery fabrication method 600 further includes pressing the mixture in the die to form an unsintered green form. The chargeable atomic battery fabrication method 600 additionally includes a step 620 of sintering the unsintered green form into a CAB unit 104A, for example, applying a current to the die to sinter the mixture into the CAB unit 104A. While a sintering technique, such as spark plasma sintering (e.g., direct current sintering) is an option for sintering in step 620, it should be understood that a furnace, hot pressing, a hot isostatic press (HIP), cold sintering, etc. can also be used for sintering in step 620. The step 620 converts the raw precursor compact 158 into the formed CAB unit 104A. In particular, sintering the mixture into a CAB unit 104A embeds the precursor material particles 151A-N inside an encapsulation material 152 comprised of the ceramic powder, and the CAB unit 104A comprises the precursor material particles 151A-N embedded inside the encapsulation material 152. The sintering can include spark plasma sintering, utilizing direct current sintering to perform eutectic sintering. During sintering, the precursor material 159 does not undergo melting, and the precursor material 159 withstands a temperature of at least 1,500 Kelvin without undergoing melting.

In step 625, chargeable atomic battery fabrication method 600 comprises packaging a plurality of CAB units 104A-G that include the CAB unit 104A in a chargeable atomic battery housing 191 to form the chargeable atomic battery 190, for example, coupling a chargeable atomic battery housing 191 to the plurality of CAB units 104A-G. In one example, the chargeable atomic battery 190 can include a single CAB unit 104A. The step 625 of packaging the plurality of CAB units 104A-G in the chargeable atomic housing 191 to form the chargeable atomic battery 190 includes coupling the chargeable atomic battery 190 to the plurality of CAB units 104A-G such that the chargeable atomic battery housing 191 is openable to uncover the plurality of CAB units 104A-G while the plurality of CAB units 104A-G are exposed to subatomic particles 160A-N within a particle radiation source 101. A chargeable atomic battery housing 191 is coupled to the plurality of CAB units 104A-G to enable the chargeable atomic battery housing191 to be openable to uncover the plurality of CAB units 104A-G while the plurality of CAB units 104A-G are exposed to subatomic particles 160A-N within a particle radiation source 101. The act of opening the chargeable atomic battery housing 191 can be done manually by an operator opening or closing a lid (e.g., connected by a hinge, sliding mechanism, or push/pull mechanism). Alternatively or additionally, the lid or door can be remotely opened or closed by an operator utilizing a hot cell and manipulators (e.g., telemanipulators), which can be include mechanical, electrical, hydraulic control devices, or a combination thereof, such as electromechanical, to avoid exposure to radiation after the initial charging cycle, as described above.

In step 630 of the chargeable atomic battery fabrication method 600, thermoelectrics 305, such as a thermopile, are coupled to the plurality of CAB units 104A-G, so that once the CAB units 104A-G are initially charged, the thermoelectrics 305 may convert the radioactive energy into electrical energy for electrical systems to utilize. Step 635 of the chargeable atomic battery fabrication method 600 includes cladding the chargeable atomic battery 190 with a radiation shield 505 that encases the plurality of CAB units 104A-G.

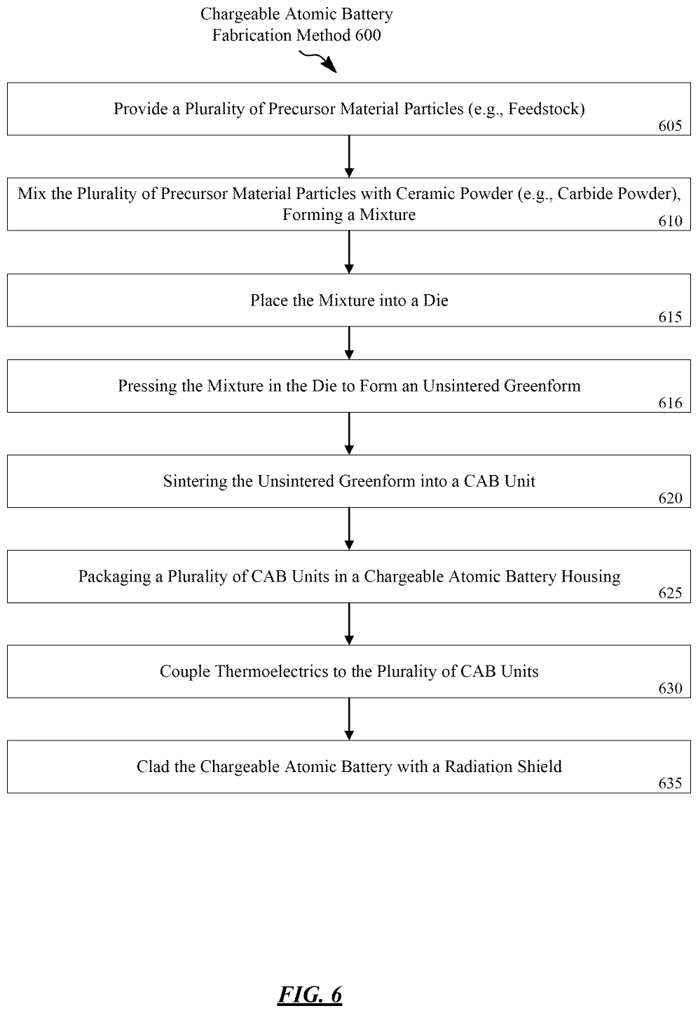

FIG. 7 is a flowchart depicting a chargeable atomic battery method 700 for initially charging and for recharging the chargeable atomic battery 190 after the chargeable atomic battery fabrication method 600 in FIG. 6. Once manufactured the chargeable atomic battery 190 can be in a stable state that is initially non-radioactive or an unstable state that is an unstable isotope. The initial charging cycle begins in step 705, which is followed by placing a precursor material 159 of a CAB unit 104A of a CAB 190 in proximity to a particle radiation source 101 in step 710.

Moving to step 715, the chargeable atomic battery method 700 further includes, during an initial charging cycle of the CAB 190, converting an initial portion of a precursor material 159 of the CAB unit 104A from a stable state or an unstable state into an activated material 162 via the particle radiation source 101. Converting the initial portion of the precursor material 159 of the CAB unit 104A from the stable state or the unstable state into the activated material 162 via the particle radiation source 101 includes exposing the precursor material 159 to subatomic particles 160A-N within the particle radiation source 101 via a reaction pathway. The activated material 162 can have a half-life approximately as long as a mission duration of the CAB 190.

Continuing to step 720, the chargeable atomic battery method 700 includes emitting radiation from the activated material 162 of the CAB unit 104A. In step 720, the CAB 190 is operating after charging, and the radiation emitted as radiation particles 161A-N includes an alpha particle, a beta particle, or a gamma particle.

Next in step 725, the chargeable atomic battery method 700 includes converting the emitted radiation from the activated material 162 into electrical power via thermoelectrics 305 of the CAB 190. Thermoelectrics 305 can convert the emitted radiation from the activated material 162 into electrical power, and provide electrical energy to an external electrical system in need of the thermal energy of the CAB 190.

Moving to step 730, the chargeable atomic battery method 700 includes discharging the activated material 162 until the activated material 162 is converted into a decayed material 163. Proceeding to step 755, the chargeable atomic battery method 700 further includes beginning a recharge cycle provided that the CAB 190 is capable of completing a recharge cycle. Upon the precursor material 159 being converted to the activated material 162, the precursor material 159 is in a partially depleted state. In the partially depleted state, the initial portion of the precursor material 159 is depleted and a recharge portion of the precursor material 159 is still convertible into the activated state via the particle radiation source 101 for recharging the CAB unit 104A. In other words, the CAB 190 is capable of completing the recharge cycle because enough precursor material 159 remains in the filling 112 and the filling 112 is not just the decayed material 163.

Continuing to step 760, the chargeable atomic battery method 700 further includes placing the precursor material 159 of the CAB unit 104A in proximity to the particle radiation source 101. Advancing to step 765, the chargeable atomic battery method 700 further includes during a recharge cycle of the CAB 190, converting the recharge portion of the precursor material 159 of the CAB unit 104A that is different from the initial portion of the precursor material 159 from a stable state or an unstable state into the activated state via the particle radiation source 101. Steps 770, 775, and 780 are the same as steps 720, 725, and 730. Finally, in step 780 of the chargeable atomic battery method 700, when the recharge portion previously converted into the activation state turns into decayed material 163, the recharge cycle is reinitiated in step 755. As long as there is sufficient precursor material 159 left in the filling 112 to enable the CAB 190 to recharge, the recharge cycle will continue. If the filling 112 includes approximately 100% decayed material 163, then the CAB 190 has reached the end of its lifetime.

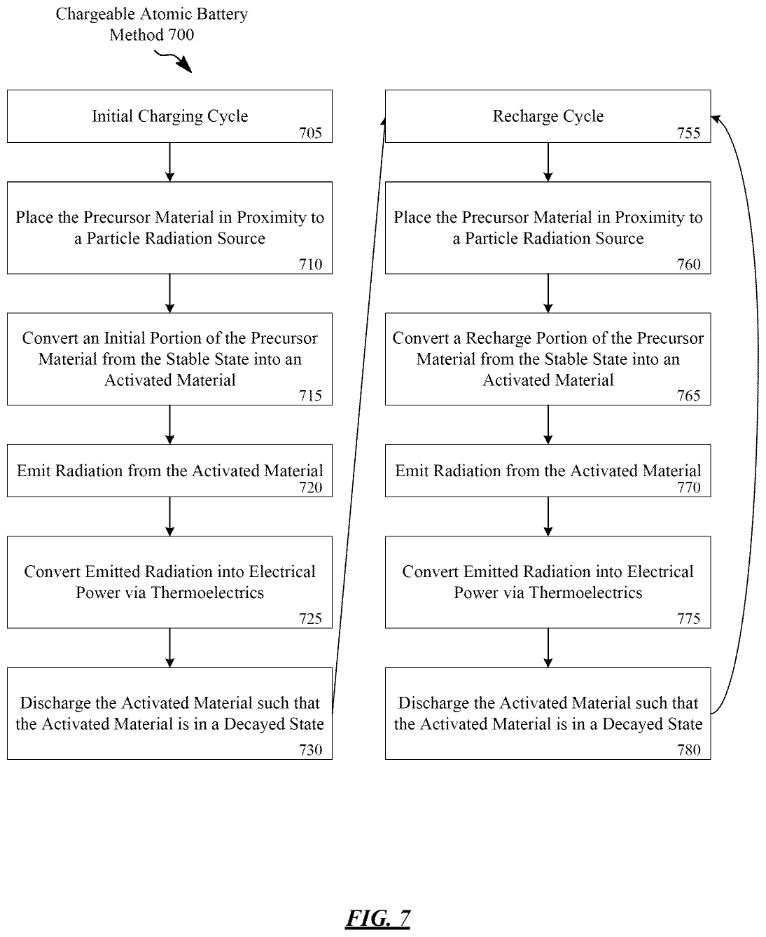

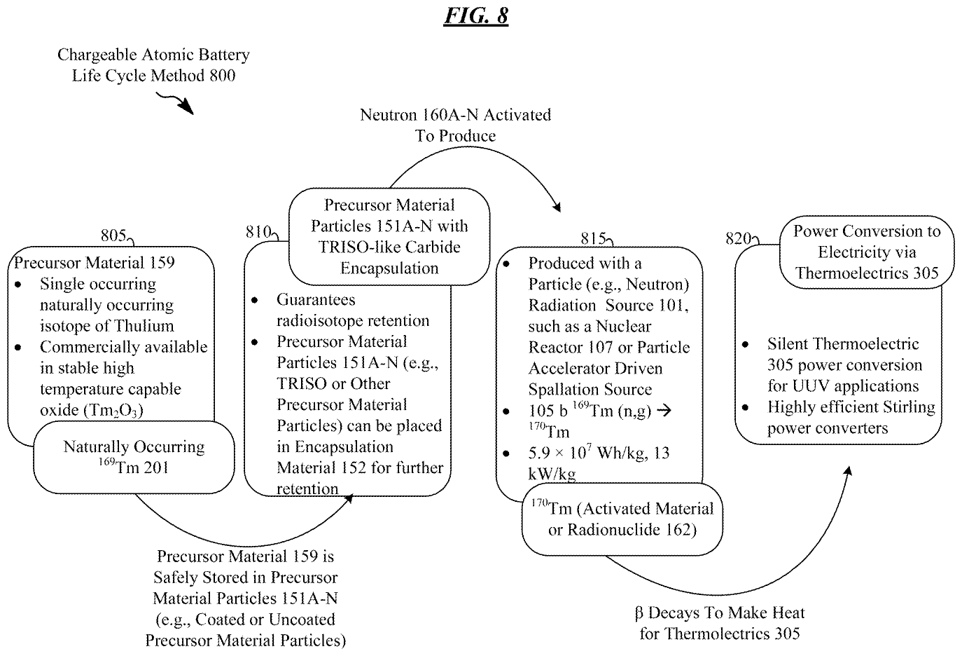

FIG. 8 is a flowchart of a chargeable atomic battery life cycle method 800 streamlining steps of FIGS. 6 and 7 to illustrate the selection, manufacturing, activation, and power production steps. In operation 805 of the chargeable atomic battery life cycle method 800, a naturally-occurring isotope, Thulium-169, is selected to be part of the precursor material 159. When manufactured as an oxide (Tm₂O₃) Thulium-169 (precursor material 159) is stable in high temperatures, as well as relatively plentiful as a naturally occurring isotope, has a thermal neutron absorption cross section of at least 50 barns, and has a half-life of about 100 days when converted into the activated material 162 of Tm-170. For this chargeable atomic battery 190 example, Thulium-169 is a good-fit selection.

In operation 810, the Tm₂O₃ is encapsulated into a TRISO-like particle: this is placing the precursor material 159 within the precursor material particle 151A. TRISO-like encapsulation is an established nuclear technology that grants radioisotope retention. In this example, the TRISO-like particle or precursor material particle 151A is placed in an encapsulation material 152, for further radioisotope retention.

Operation 815 sees the precursor material particle 151A neutron activated. This neutron activation is produced with a particle radiation source 101 or neutron source such as a reactor or accelerator driven spallation source. The precursor material 159 of Thulium-169 is now converted into an activated material 162. The activated material 162 includes Thulium-170, and produces 5.9×10⁷ watt-hours per kilogram, and will produce 13 kilowatts per kilogram as the activated precursor material 159 emits radiation.

Operation 820 shows the benefits of the beta decay of the activated material 162 (Thulium-170) to make heat. The beta decay provides off-the-shelf power conversion via silent thermoelectric power conversion for unmanned underwater vehicle (UUV) applications, and highly efficient Stirling power converters in other applications. Eventually, the activated material 162 becomes decayed material 163.

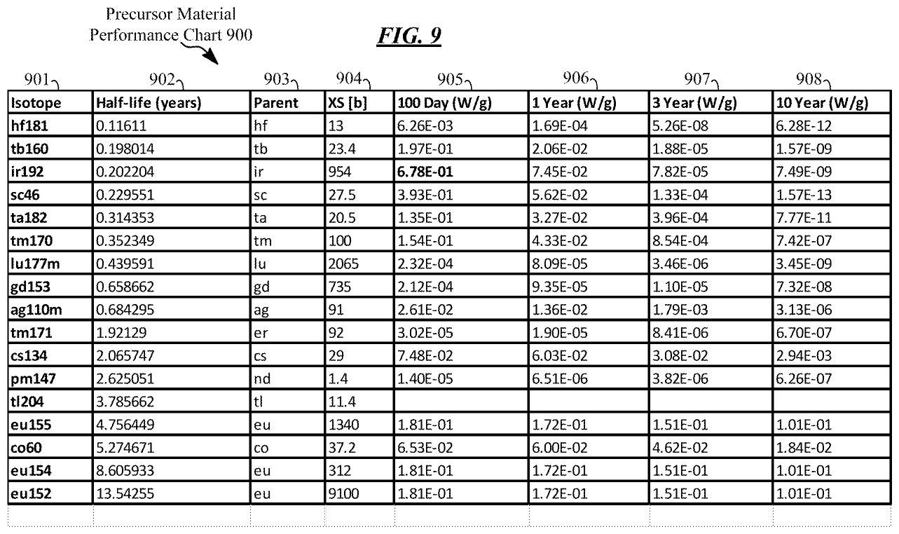

FIG. 9 is a precursor material performance chart 900 of activated isotopes, their half-lives, parent isotopes, and power output over a range of days. Column 901 of the precursor material performance chart 900 identifies the activated material (radionuclide) 162 that will be providing the energy from the chargeable atomic battery 190. Column 902 displays the half-life of that activated material 162 from column 901. In column 903, the parent precursor atom 201 of the activated material 162 from column 901 is shown. Column 904 is the thermal neutron cross section for producing the nuclide in column 901 from the chemical element in column 903. Columns 905-908 of the precursor material performance chart 900 show the electrical output of the activated material 162 from column 901 at various points in time. Column 905 shows the watts per gram output 100 days after irradiation. Column 906 shows the watts per gram output 1 year after irradiation. Column 907 shows the watts per gram output 3 years after irradiation. Column 908 shows the watts per gram output 10 years after irradiation.

FIGS. 10A-20 describe a chargeable atomic battery (CAB) 190 and a standardized pre-irradiation encapsulation manufacturing method 1100 to ease manufacturing and improve safety features. A CAB unit 104A can, in some examples, be manufactured through a non-radioactive process and then placed in a radiation field of a particle radiation source 101, such as a fission nuclear reactor core 101 to convert a portion of a precursor material 159 that can be non-radioactive into an activated material (radioisotope) 162. Alternatively or additionally, the precursor material 159 can include an unstable element, such as Neptunium-237, which may be converted into an activated material 162. The activated material 162 can include Plutonium-238. The radioisotope conversion process is called “charging.” After charging, the CAB unit 104A is ready for use and can be combined with additional CAB units 104B-N into a CAB stack 200 to achieve the desired activity and integrated into a CAB pack 300 or product, such as an independent device, that uses the radioactivity for the desired application such as heating, electricity, and passive x-ray sources. A pre-irradiation encapsulation manufacturing method 1100 can use a die press and sintering process to produce a CAB unit 104A with the precursor material 159 fully encapsulated by the encapsulation material 152 and/or additive manufacturing techniques. During and after the charging process, the encapsulation material 152 serves as a barrier, preventing release of the activated material 162.

FIG. 10A illustrates a CAB 190 that includes at least one CAB unit 104. The at least one CAB unit 104 includes an encapsulation material 152 and a precursor material 159. The precursor material 159 can be embedded within the encapsulation material 152. FIG. 10B is cutaway view of the CAB unit 104 of FIG. 10A. The at least one CAB unit 104 can include precursor material particles 151A-N. The precursor material particles 151A-N include a precursor kernel 153 formed of a precursor material 159 that can be initially manufactured in a stable state or an unstable state and convertible into an activated material 162 that is an activated state via irradiation by a particle radiation source 101. The unstable state can be an unstable radioisotope. For example, in the unstable state, the precursor material 159 can include a radioactively-unstable nuclide. The activated state can be a radionuclide.

The precursor kernel 153 can include Neptunium-237, Thulium-169, Europium-153, Europium-151, or Cobalt-59. Chargeable atomic battery 190 further includes a chargeable atomic battery 191 housing to hold the plurality of CAB units 104A-G. A radioisotope thermoelectric generator can include the at least one CAB unit 104A and thermoelectrics 305 coupled to the at least one CAB unit 104A to convert radioactive emissions of the activated material into electrical power (e.g., electricity production). Alternatively, the chargeable atomic battery 190 can be used as an independent heat source for direct heat applications.

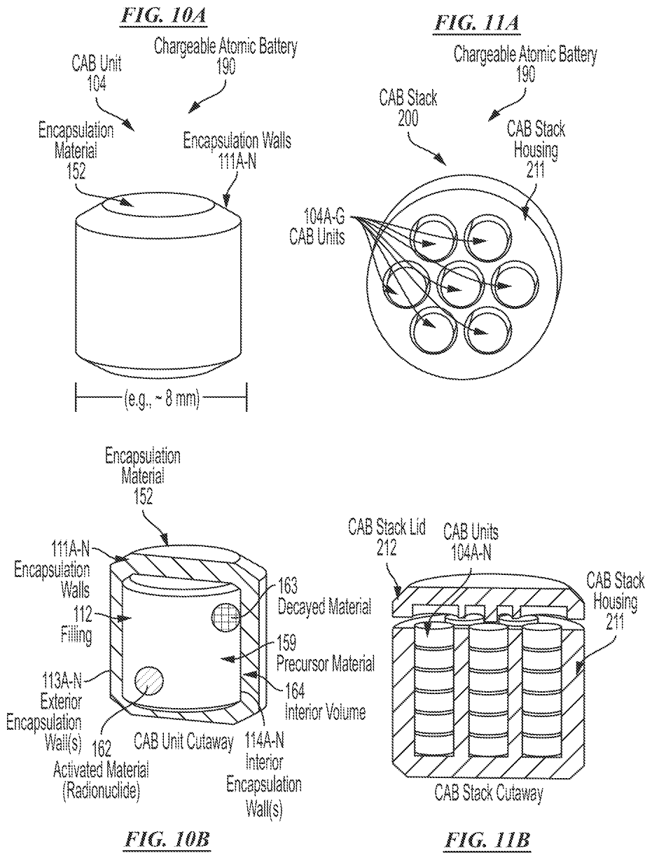

Notionally, the form factor of the CAB unit 104 is small as the CAB unit 104 is a basic unit that can be incremented by integrating multiple CAB units 104A-N into a CAB stack 200 as shown in FIGS. 11A-B. Additionally, the CAB unit 104 is a small form factor in the example because of limited space, self-shielding, and thermal constraints when charging in a particle radiation source 101. The CAB unit 104 can be approximately 8 mm in diameter, 8 mm in height, and with a 1 mm thick encapsulation wall 111, but designs can deviate significantly.

CAB unit 104 is initially manufactured with an encapsulation wall 111 formed of the encapsulation material 152 and a filling 112 formed of the precursor material 159 inside the encapsulation wall 111. CAB unit 104 provides an intrinsic safety case against accidental release of an activated material 162, eases handling and facility requirements, and provides a repeatable production pathway that can be applied to many different radioisotopes from various precursor material(s) 159 using a wide range of particle radiation sources 101A-N.

Precursor material 159 can be a stable isotope or an unstable isotope. During an initial charging cycle of the CAB 190, a particle radiation source 101 converts a portion of the precursor material 159 into an activated material 162 that is an activation state. Accordingly, a charging method for the chargeable atomic battery 190 can include: (1) placing the CAB unit 104 in a radiation field of the particle radiation source 101; and (2) converting, via the particle radiation source 101, the precursor material 159 into the activated material 162.

The filling 112 formed of the precursor material 159 is convertible into the activation state, in which case a subset (fraction) or all of the precursor material 159 becomes activated material 162 upon being exposed to subatomic (e.g., neutron) particles 160A-N from a particle radiation source 101. The particle radiation source 101 converts the precursor material 159 into the activation material 162 that is in the activation state based on a reaction pathway. The particle radiation source 101 can be implemented like the nuclear reactor core described in FIG. 2C and the associated text of U.S. Patent Pub. No. 2020/0027587 to Ultra Safe Nuclear Corporation of Seattle, Washington, published Jan. 23, 2020, titled “Composite Moderator for Nuclear Reactor Systems,” the entirety of which is incorporated by reference herein.

After charging a subset (fraction) or all of the precursor material 159 is converted into activated material 162, and eventually the activated material 162 decays into decayed material 163. A suitable encapsulation material 152 generally satisfies one or more of the following criteria: high temperature capable; chemically nonreactive during manufacturing, charging, and operation; mechanically strong; resistant to crack propagation, resistant to diffusion or any other means of transport of the activated material 162 through its grains or grain boundaries; resists significant degradation of material properties during irradiation and charging by the particle radiation source 101; favorable thermodynamic material properties such as thermal conductivity; and a low nuclear activation cross-section. This listing is not exhaustive, and there may be other criteria depending on the application.

Typically, the encapsulation material 152 does not activate into a radionuclide under irradiation from the particle radiation source 101. A possible exception is that some amount of short-lived radionuclides may be acceptable. After charging, CAB units 104A-N with short-lived activated material 162 can be placed temporarily in a storage site to allow the short-lived radionuclides to decay to negligible amounts. Two example materials are Aluminum and Silicon, which activate into Aluminum-28 and Silicon-31. However, these materials have short half-lives on the order of a few hours and will decay almost completely into stable isotopes.

Activated material 162 emits subatomic particles 160A-N through nuclear decay. The activated material 162 is a radionuclide, also referred to as a radioactive nuclide, radioactive isotope, or a radioisotope. The activated material 162 includes an alpha emitting isotope, a beta emitting isotope, a gamma emitting isotope, or a combination thereof. In a first example, the activated material 162 includes the beta emitting isotope that produces Bremsstrahlung radiation for a passive x-ray source. In a second example, the activated material 162 includes the gamma emitting isotope that directly produces high energy x-rays for a passive x-ray source.

In the example of FIGS. 10A-B, type 1 (wall) encapsulation 801 (see FIG. 17) is shown, in which the CAB unit 104 includes one more encapsulation walls 111A-N that encapsulate the filling 112. The filling 112 includes the precursor material 159 that converts into the activated material 162 upon irradiation by the particle radiation source 101. When initially manufactured and prior to the initial charging cycle, filling 112 can include either 100% precursor material 159 or additional encapsulation barriers, such as type 2 (wall and matrix) encapsulation 802 (see FIG. 17); or type 3 (wall, matrix, and coating) encapsulation 803 (see FIG. 17).

Precursor material 159 can be a filling 112 inside an interior volume (e.g., cavity) 164 formed of the encapsulation material 152, etc. A body that includes one or more encapsulation walls 111A-N can be formed of the encapsulation material 152. The encapsulation walls 111A-N include one or more exterior (e.g., outer) encapsulation walls 113A-N and one or more interior (e.g., inner) encapsulation walls 114A-N. The interior encapsulation walls 114A-N interface the filling 112 formed of the precursor material 159 (and activated material 162 if converted into the activation state and/or decayed material 163). Interior encapsulation walls 114A-N surround an interior volume 164 of the encapsulation material 152 that is filled with or lined with the precursor material 159 (and activated material 162 if converted into the activation state and/or decayed material 163). The one or more exterior encapsulation walls 113A-N and the interior encapsulation walls 114A-N can be continuous or discontinuous surfaces. The body of encapsulation walls 111A-N can be circular or oval shaped (e.g., a spheroid, cylinder, tube, or pipe). The body of encapsulation walls 111A-N can be square or rectangular shaped (e.g., cuboid) or other polygonal shape. The one or more interior encapsulation walls 114A-N of the encapsulation material 152 can be one continuous interior encapsulation wall 114 surrounding the filling 112 of the precursor material 159 (and activated material 162 if converted into the activation state and/or decayed material 163). Alternatively, the one or more interior encapsulation walls 114A-N formed of the encapsulation material 152 can be a plurality of discontinuous interior encapsulation walls 114A-N, which depend on the shape of the precursor material 159 filling the interior volume 164 of the encapsulation material 152. If the filling 112 of precursor material 159 is a spheroid in three-dimensional space, then there is one continuous interior encapsulation wall 114 of the encapsulation material 152 in the interior volume 164 surrounding the precursor material 159. If the filling 112 is a cuboid or polygonal shape in three-dimensional space, then there are a plurality of continuous interior encapsulation walls 114A-N of the encapsulation material 152 in the interior volume 164 surrounding the precursor material 159.

FIG. 11A illustrates a CAB 190 that includes a CAB stack 200 and a top view of the CAB stack 200. FIG. 11B is a cutaway view of the CAB stack 200 of FIG. 11A containing a few dozen CAB units 104A-N of FIGS. 10A-B. CAB stack 200 includes a plurality of the CAB units 104A-N and a CAB stack housing 211 designed to integrate the plurality of CAB units 104A-N into a single unit. The CAB stack housing 211 includes a high-temperature material to serve as an additional encapsulation barrier. In one example, the high-temperature material includes tungsten.

CAB stack 200 is a device to integrate many CAB units 104A-N together. As shown in FIG. 11B, the CAB stack 200 includes a CAB stack housing 211 and a CAB stack lid 212. The CAB stack housing 211 can hold 42 CAB units 104A-N. The CAB units 104A-N are placed inside the CAB stack housing 211, and then the CAB stack lid 212 can be attached 202 by threads, welding, etc. or some other method to form the CAB stack 200.

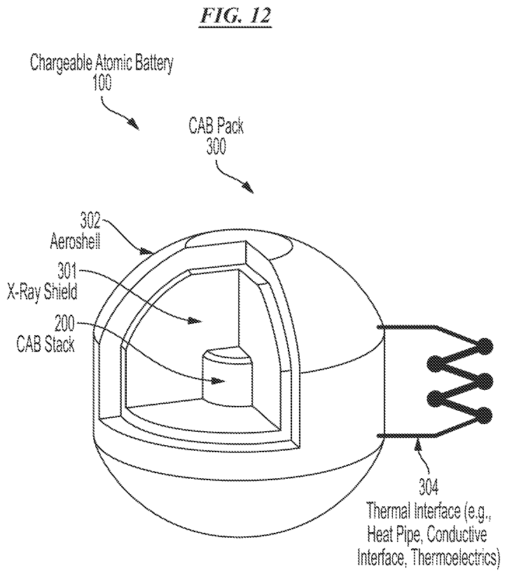

FIG. 12 illustrates a CAB 190 that includes a CAB pack 300. The CAB pack 300 includes the CAB stack 200 of FIGS. 11A-B, an ablative aeroshell 302, and an x-ray shield 301 shown in a cutaway view. Hence, in the example of FIG. 12, the CAB 190 is a space-bound x-ray emitting CAB 190. Generally, the CAB pack 300 integrates the CAB stack 200 with any other required components for either thermal, safety, x-ray, or other application requirements. Depending on the application requirements, the CAB pack 300 includes at least one of an x-ray shield 301, a thermal interface 304, or an aeroshell 302.

In FIG. 12, the CAB stack 200 is contained within the x-ray shield 301. The x-ray shield 301 includes a heavy metal to substantially block x-rays from leaving the CAB stack 200. The thermal interface 304 includes a conductive interface, a heat pipe, or a combination thereof and directs heat produced by the CAB stack 200 to the conductive interface, the heat pipe, or the combination thereof. Alternatively or additionally, the thermal interface 304 can include thermoelectrics 305, such as an array of thermocouples to convert the heat released by the decay of the precursor material 159 in a radioactive state (e.g., activation state) into electricity by the Seebeck effect. Aeroshell 302 includes an ablative material to protect the CAB stack 200 from high temperature reentry plasma erosion and release during travel. The x-ray shield 301, the thermal interface 304, or the aeroshell 302 provide additional encapsulation layer around the CAB stack 200.

CAB pack 300 can be placed within a product, such as an independent device. For example, the independent device may include the CAB pack 300 and use decay radiation, thermal heat, or a combination thereof for heating, production of electricity, x-ray fluorescence detection, sanitization, or propulsion.

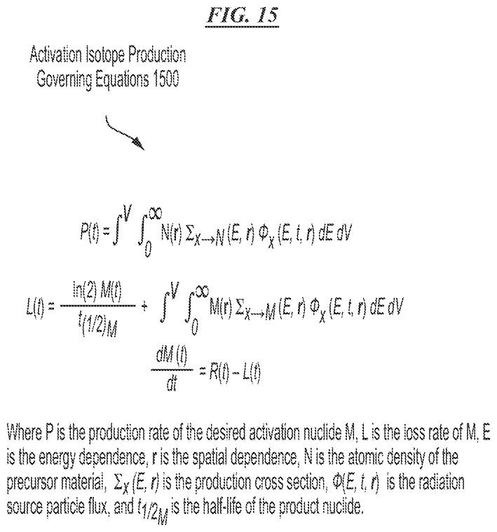

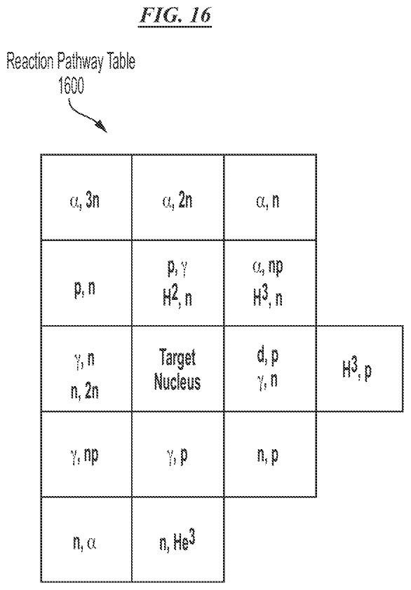

CAB unit 104 can be used to produce and contain high activity activated material 162 that can produce significant amounts of heat and or x-ray radiation that can be used for useful purposes. The CAB unit 104 can accommodate many different types of precursor material(s) 159 forming the filling 112 and activated material 162 if there is a reasonable production rate from the particle radiation activation pathways as described in FIGS. 15-16.

CAB unit 104 is compatible with various types of particle radiation particle sources 101A-N such ions in accelerators, high energy fusion neutrons, lower energy fission neutrons, spallation neutron sources, and high energy photon generators. The particle radiation source 101 penetrates the encapsulation wall 111 and into the filling 112 that includes the precursor material 159. Higher energy particle radiation sources 101A-N and neutral sources generally penetrate more deeply into the precursor material 159 and are more suitable for charging of the CAB unit 104 to produce activated material 412.

The CAB unit 104 is a standardized form factor and is enabled by a manufacturing process adapted for many different commercial radioisotopes. The CAB stack 200 is a device that can hold multiple CAB units 104A-N such that it can be adapted to meet different power needs for various use cases. The CAB pack 300 contains the atomic battery stack 200. CAB pack 300 can integrate a radioisotope specific and mission-specific components, such as an x-ray shield 301, thermal interface(s) 304 (e.g., conductive interface, heat pipe, or thermoelectrics 305), and an aeroshell 302 for accidental launch failure and re-entry in the case of missions traveling into orbit. The CAB pack 300 is designed to provide either heat or radiation as a general-purpose resource. Commercial customers can utilize these resources in their vehicles and missions for various purposes, such as electrical power generation, thermal heating, remote sensing, propulsion, sanitization, etc.

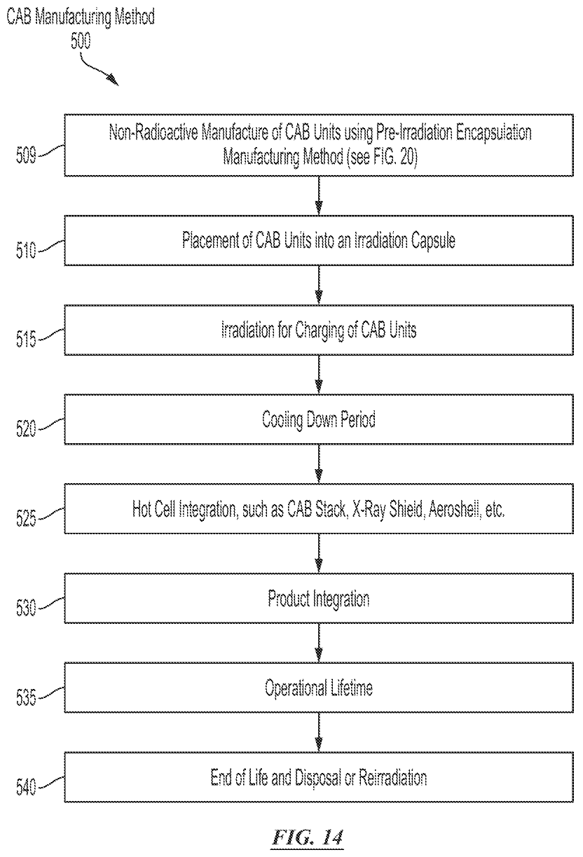

CAB 190 is designed to have superior safety attributes. As described in FIG. 14, a significant innovation of the CAB 190 is a CAB manufacturing method 500 that eases the production process and eliminates the need for expensive radiochemical processing. CAB manufacturing method 500 provides an intrinsic level of encapsulation that contains an activated material (radionuclide) 162 converted from the precursor material 159 against release into the environment. The CAB manufacturing method 500 is based upon a system with two distinct materials: (1) an encapsulation material 152; and (2) a precursor material 159. The encapsulation material 152 is designed to provide a barrier that fully contains a filling 112 formed of the precursor material 159 and any converted activated material 162 and decayed material 163. The filling 112 can be initially not radioactive during the CAB manufacturing method 500. The filling 112 can be a stable compound, but when the precursor material 159 is exposed to a radiation field such as a particle radiation source 101, the precursor material 159 interacts with that radiation and a portion of the stable precursor material 159 is converted into radioactive activated material 162. Alternatively the filling 112 can include unstable element(s), such as Neptunium-237 (Np-237), and, when the unstable element(s) are exposed to a radiation field such as a particle radiation source 101, the precursor material 159 interacts with that radiation and a portion of the unstable precursor material 159 is converted into radioactive activated material 162, such as Plutonium-238 (Pu-238). Np-237 absorbs a neutron and becomes Np-238. Np-238 then undergoes beta decay to become Pu-238. This activation process is called “charging.”

Neptunium-237 is significantly easier to work with than Plutonium-238. Encapsulating Neptunium-237 in the manner described via three different types of encapsulations 801, 802, and 803 (see FIG. 17) provides enhanced safety attributes and is much safer to work with than Plutonium-238. Converting encapsulated Neptunium-237 into encapsulated Plutonium-238 can enhance: (1) safety; (2) technical/manufacturing; (3) regulatory framework compliance; and (4) marketability. For example, during and after the charging process, the encapsulation material 152 serves as a barrier, preventing release of unstable elements, such as Neptunium-237, and the activated material 162, such as Plutonium-238.

After the charging of the CAB units 104A-F, there is a cooling down period, which is a short waiting period allowing any undesired short-lived radioisotopes to decay. In the case of creating CAB units 104A-F in which the activated material 162 includes Pu-238, the waiting period can be greater than a year. After this time, the CAB units 104A-F are ready to be integrated with the CAB stack 200 and CAB pack 300. This integration is typically done inside a radiation hot cell due to x-rays generated by the activated material (radionuclide) 162. When the activated material 162 includes Tm-170, x-ray emissions may be a primary concern because the x-rays are generated by beta particles slowing down. If the activated material 162 includes Pu-238 (and fission products), Co-60, Eu-152, etc., then gamma radiation (high-energy photons emitted by a nucleus) may be the primary concern. After integration, the CAB pack 300 can include a radiation shield (e.g., x-ray shield 301) and is safe to transport to a customer.

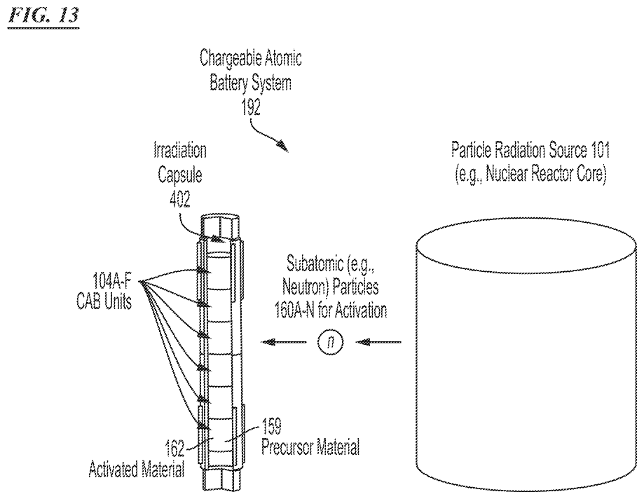

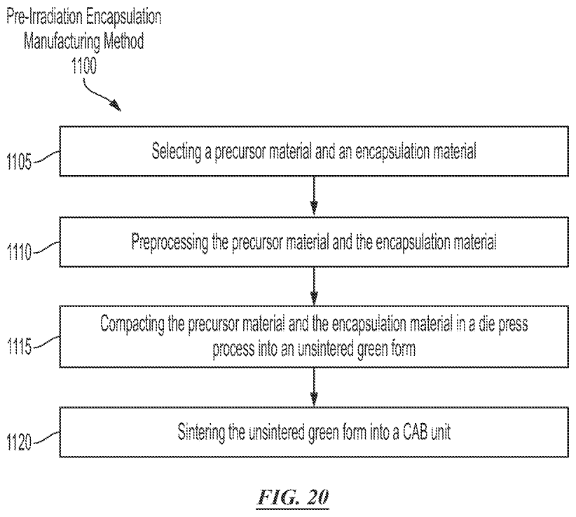

As described in FIG. 20, a pre-irradiation encapsulation manufacturing method 1100 can yield three different types of encapsulations with various degrees of redundant encapsulation, as shown in FIG. 8. An encapsulation wall 111 provides a single level of encapsulation. The filling 122 inside the encapsulation wall 111 can be comprised of pure precursor material 159. Alternatively, for a double level of encapsulation, the filling 112 can be a mixture of the precursor material 159 and the encapsulation material 152 designed to form a contiguous encapsulation matrix 150 that serves as a double level of encapsulation. For triple or more levels of encapsulation, the encapsulation matrix 150 mixture type encapsulation can be upgraded to include one or more coatings on the precursor kernel 153 to provide additional precursor encapsulation coatings 154-157, yielding three or more physical barriers focused on preventing the release of encapsulated activated material 162. For example, triple or more levels of encapsulation can prevent the release of Plutonium-238 in the filling 112 or precursor material 159 in an unstable state, such as Neptunium-237. The encapsulation coatings 154-157 can include graphite, low density graphite, silicon carbide (SiC), titanium carbide (TiC), zirconium carbide (ZrC), niobium carbide (NbC), tantalum carbide (TaC), hafnium carbide, ZrC-ZrB₂ composite, ZrC-ZrB₂-SiC composite, or a combination thereof. FIG. 13 illustrates a CAB system 192 that includes an irradiation capsule 402 containing six CAB units 104A-F of FIGS. 10A-B undergoing irradiation from subatomic (e.g., neutron) particles 160A-N from a particle radiation source 101 that is a fission nuclear reactor core 101. FIG. 14 is a flowchart showing a CAB manufacturing method 500 for a CAB 190. Beginning in step 509 of the CAB manufacturing method 500, CAB units 104A-F are fabricated using a pre-irradiation encapsulation manufacturing method 1100, which is described in FIG. 20. The pre-irradiation encapsulation manufacturing method 1100 of FIG. 20 produces uncharged CAB units 104A-F that are safe to handle.

Continuing to step 510 of the CAB manufacturing method 500, the CAB units 104A-F are placed inside of an irradiation capsule 402, as shown in FIG. 13. The irradiation capsule 402 can vary significantly depending on the type of the particle radiation source 101 that is used for charging, and the irradiation capsule 402 may not be required in some cases. The purpose of the irradiation capsule 402 is to isolate and integrate the CAB units 104A-F within the geometry of the particle radiation source 101 and provide a thermal radiation interface to cool the CAB units 104A-F as the CAB units 104A-F are charging.

Moving to step 515 of the CAB manufacturing method 500, irradiation capsule 402 is then placed within range of the particle radiation source 101 as shown in FIG. 13. The irradiation capsule is then irradiated by the subatomic particles 160A-N for activation, which converts a subset (fraction) or all of the precursor material 159 into an activated material 162. The desired irradiation time can be highly variable depending on the intensity of the particle radiation source 101, the cross section of the reaction, the half-life of the activated material 162, the cost of operation, possible damage to the CAB units 104A-F at higher radiation fluences, the amount of time the particle radiation source 101 can be active, and other parameters. Typically, only a subset of the precursor material 159 is activated for optimal production conditions.

Typically, the precursor material 159 and the encapsulation material 152 have some atomic impurities from the material supply and possibly from additives or inclusions during the pre-irradiation encapsulation manufacturing method 1100 of FIG. 20. These impurities are evaluated for the impact upon the CAB units 104A-F, especially during irradiation for charging when some of the impurities may interact with the particle radiation source 101 to produce undesirable radioisotopes.

Continuing now to step 520 of the CAB manufacturing method 500, the CAB units 104A-F inside the irradiation capsule 402 enter a cooling down period, in which the CAB units 104A-F do not undergo further irradiation from the subatomic particles 160A-N. The CAB units 104A-F remain inside the irradiation capsule 402 and are not handled during the cooling down period. Typically, there are some short-lived radioisotopes produced from the precursor material 159 during the charging process of the CAB units 104A-F. Some of these short-lived radioisotopes are from impurities within the CAB units 104A-F, and others are from low yield cross-section paths. It is usually advantageous to allow the CAB units 104A-F to have these short live isotopes to decay or “cool down” before opening the irradiation capsule 402.

Moving to step 525 of the CAB manufacturing method 500, after the cooling down period, the irradiation capsule 402 is moved to a hot cell, and the CAB units 104A-F are integrated into a CAB stack 200, CAB pack 300, etc. A hot cell is a shielded room with remotely operated manipulators. The irradiation capsule 402 is then opened and the CAB units 104A-F are removed. The CAB units 104A-F are then quality checked and integrated into the CAB stack housing 211 of the CAB stack 200 and the CAB stack lid 212 is closed. The CAB stack 200 also provides an additional layer of encapsulation and is manufactured from a high-temperature material that is mechanically strong, such as Tungsten for superior mechanical resistance.

The CAB pack 300 is a device that integrates the CAB stack 200 with any other required components for either thermal, safety, x-ray, or other application requirements. For an activated material 162 that produces x-rays, the CAB pack 300 can integrate an x-ray shield 301. This x-ray shield 301 is typically formed of a heavy metal for mass sensitive applications, but x-ray shield 301 can also be formed of almost any material for applications where higher mass is not an issue. The x-ray shield 301 is attached to the CAB pack 300 and is now safe for limited handling and can be taken out of the hot cell if desired. For an activated material 162 that does not produce x-rays or other penetrating radiation, no x-ray shield 301 is required.

For applications where thermal heat is produced in significant quantities, the CAB pack 300 can include a thermal interface 304, which can include thermal distribution devices, such as conductive interfaces or heat pipes. For applications where launch into space is required, the CAB pack 300 can integrate an aeroshell 302.

Moving to step 525 of the CAB manufacturing method 500, after hot cell integration, the CAB pack 300 is ready for product integration with an independent device. Product integration involves integrating the thermal interface 304 of the CAB pack 300 to a use application, for example, connecting the thermal interface 304 with a thermoelectric generator or other independent device for power production. Another example is integrating the CAB pack 300 with an independent device that can take the heat from the CAB pack 300 into a fluid for propulsion. The implementation of the product integration can be widely varied. In addition to the product integration, licensing the product may be required. When the precursor material 159 is converted into activated material (radionuclide) 162 during charging, the CAB units 104A-F are likely subject to user licenses from the national/federal, state, or local agencies depending on the location, use case, and other factors.

In step 535 of the CAB manufacturing method 500, after the CAB pack 300 is integrated with the product, the CAB pack 300 can then be deployed on a mission. The CAB pack 300 faithfully produces radiation or heat according to a half-life of the activated material 162, and the independent device is able to use these resources to accomplish the mission.

Finishing in step 540 of the CAB manufacturing method 500, after some amount of time, the activated material 162 in the CAB units 104A-F of the CAB pack 300 decay to a point where the independent device will no longer receive enough heat or radiation from the CAB pack 300. This is typically 1-5 half-lives, but can be much longer. The CAB pack 300 can be disposed of at this point, but would still be considered radioactive. Between 10-20 half-lives, the activated material 162 of the CAB pack 300 will have decayed into the decayed material 163 such that the CAB pack 300 is no longer considered radioactive and can be safely handled and easily disposed of

In some cases, the CAB units 104A-F may be able to be re-irradiated or “recharged” to convert more of the precursor material 159 into the activated material 162. This may have practical value in certain situations where the half-life of the activated material 162 is short, there is an easily accessible particle radiation source 101, and the properties of the encapsulation material 152 are not limited to one charge cycle. If these criteria are met, then the CAB units 104A-F can be subject to many recharge cycles after an initial charging cycle. Eventually, after some number of charge cycles, all of the precursor material 159 is converted into the activated material 162, then the activated material 162 decays into the decayed material 163 and the CAB units 104A-F are no longer able to be recharged.

FIG. 15 illustrates activation isotope production governing equations 1500 describing the activation of an activated material (radionuclide) 162 from a precursor material 159. The production rate (P) is the product of a nuclear cross-section, the flux of the particle radiation source 101, and a density of precursor material 159. In addition to a high production rate (P), a reasonable loss rate (L) is achieved. The half-life of the activated material 162 produced is sufficiently long for production and after production to last long enough for the use case of the CAB unit 104. During charging, the activated material 162 is converted from the precursor material 159 and may occasionally become double activated. This is usually undesirable as double conversion reduces the amount of the desired activated material 162 and introduces a new isotope typically with a half-life that is much shorter or much longer than desired for the CAB unit 104.

FIG. 16 illustrates a reaction pathway table 1600 for several particle radiation activation pathways. Through the reaction pathways, the precursor material 159 is convertible into an activated state, generally as an activated material 162 via irradiation by some particle radiation source 101.

FIG. 17 depicts a CAB encapsulation chart 1700 of three types of encapsulation techniques for the CAB units 104A-N of FIGS. 10A-B compared to a traditional approach with no encapsulation. CAB encapsulation chart 1700 shows, in great detail, the three different filling configurations of: type 1 (wall) encapsulation 801, type 2 (wall and matrix) encapsulation 802, and type 3 (wall, matrix, and coating) encapsulation 803. Type 1 encapsulation 801 is comprised fully of encapsulation wall(s) 113A-N formed of the encapsulation material 152 around a filling 112 of the precursor material 159. Type 2 encapsulation 802 is comprised of an encapsulation matrix 150 that is a continuous matrix formed of encapsulation material 152 fully surrounding a small precursor kernel(s) 153A-N of precursor material 159. Type 3 encapsulation 803 is like type 2 encapsulation 802, but includes precursor encapsulation coatings 154-157 of encapsulation material 152 surrounding the precursor kernel(s) 153A-N formed as precursor material particles 151A-N. The encapsulation material 152 may include one or more distinct materials. For example, the wall, matrix, and coating encapsulation can be composed of different chemical compounds, but are collectively referred to as being formed of encapsulation material 152. In the type 0 (radioisotope only) traditional approach 805, there is no encapsulation and no precursor material 159, just a radionuclide that is not encapsulated.

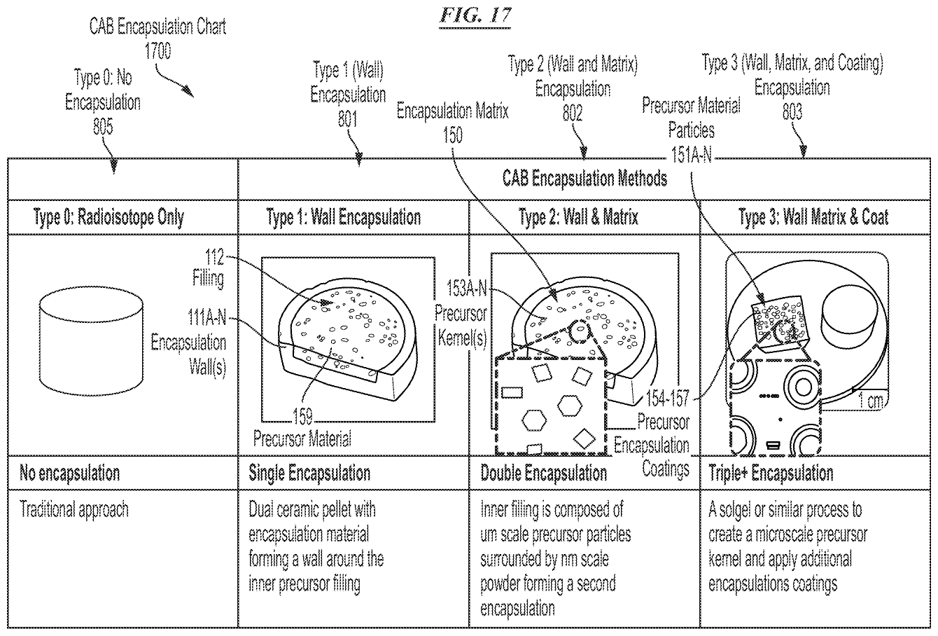

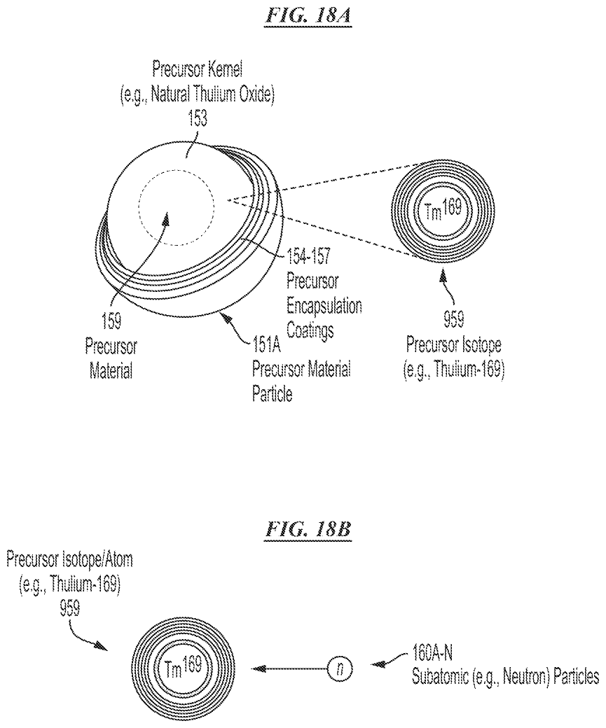

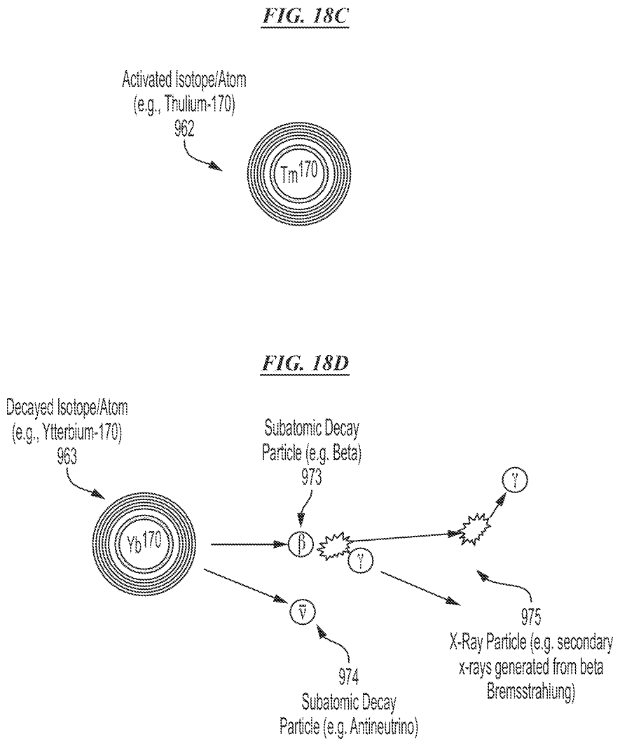

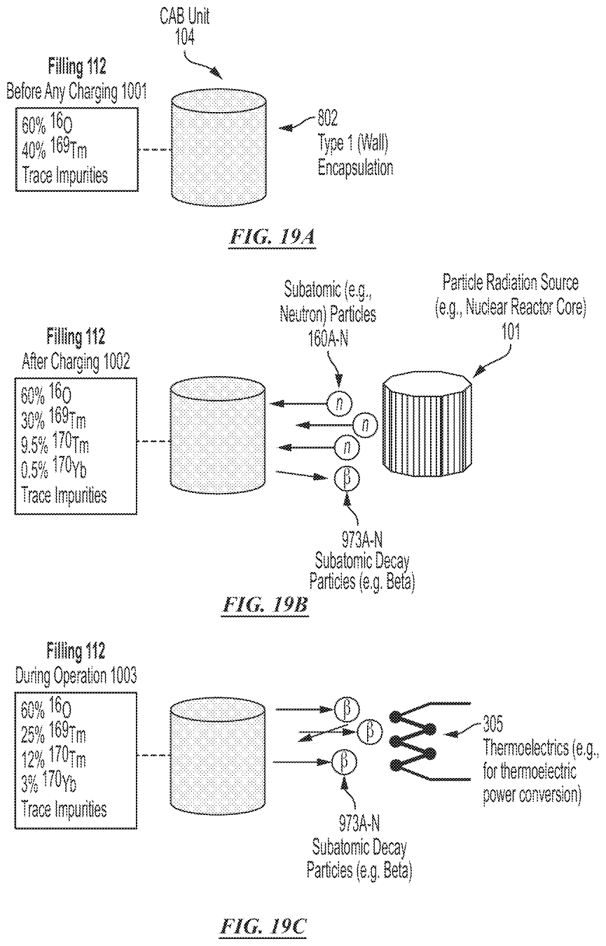

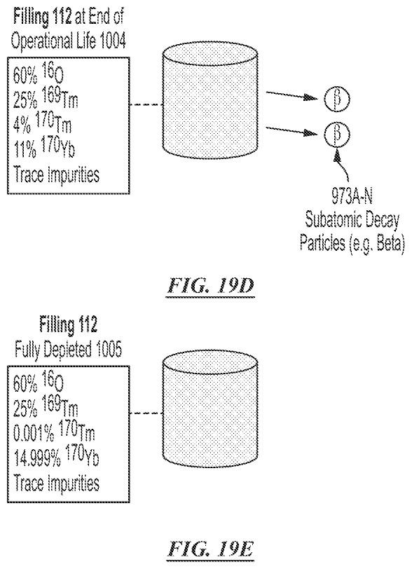

In the case of multiple encapsulation materials, such as type 2 (wall and matrix) encapsulation 802 and type 3 (wall, matrix, and coating) encapsulation 803 if the encapsulation walls 111A-N have negligible activation, the encapsulation matrix 153 and precursor encapsulation coatings 154-157 can have some activation as long as they serve a function as shown in FIGS. 18A-19E. As a purely illustrative example, Iron will activate in a low yield cross-section to produce the radioisotope Fe-55. However, Iron may, for example, provide a structural benefit and could be included in the encapsulation matrix 153 or precursor encapsulation coatings 154-157 to improve the safety features of the CAB unit 104.

FIG. 18A illustrates a precursor kernel 153 with several precursor encapsulation coatings 154-157 and a callout of a single atom of precursor isotope 959 (Thulium-169) from the precursor kernel 153. When initially manufactured, the precursor kernel 153 can be comprised entirely of the precursor material 159 or comprised of a mixture of precursor material 159 and encapsulation material 152. The precursor material 159 is focused upon an isotopic concentration of a desirable isotope, shown as precursor isotope 959 (Thulium-169). The precursor isotope 959 is an isotope that is part of a precursor element. In FIG. 18A, precursor kernel 153 includes the precursor element and is composed of one or more isotopes, and typically, only one isotope will have the desired radionuclide production pathway. A precursor element can be enriched if desired to have a greater proportion of the desired isotope or remove isotopes with an undesirable radionuclide production pathway. The enrichment process is not always necessary and, in some cases, even a very small amount of the precursor isotope 959 can be effective and even desirable for high cross-section precursor isotopes that could suffer from significant self-shielding.

The precursor kernel 153 can be composed of precursor isotope 959, activated isotope 962, decayed isotope 963, and non-interacting isotopes. The non-interacting isotopes include atoms, such as carbon and oxygen to chemically stabilize the materials, for example, the Oxygen in Thulium Oxide.

As shown, precursor kernel 153 is in a chemical format such as a metal, oxide, carbide, nitride, or other material of interest, which may contain additional atoms. An example of a precursor kernel 153 is Natural Thulium Oxide. The chemical form of the precursor kernel 153 in a CAB 190 can be chosen for compatibility with the pre-irradiation encapsulation manufacturing method 1100, chemical compatibility with encapsulation material 152, high-temperature capability, mechanical properties, thermodynamic properties, and other needs.

FIG. 18B illustrates a subatomic (e.g., neutron particles) 160A-N interacting with the precursor isotope 959 (Thulium-169). When placed into a particle radiation source 101, the CAB unit 104 begins to activate or convert the precursor isotope 959 into the activated isotope 962 (Thulium-170).

FIG. 18C illustrates the precursor isotope 959 (Thulium-169) of FIG. 18B having absorbed a neutron and being converted into an activated isotope 962 (Thulium-170).

FIG. 18D illustrates the activated isotope 962 of (Thulium-170) of FIG. 18C decaying into a decayed isotope 963 of stable decayed material 163 (Ytterbium-170 isotope) and emitting subatomic decay particles 973, 974. As shown, the activated atom 962 eventually decays according to its half-life. A half-life is the amount of time on average that half of the atoms would decay from a material. When an activated isotope 962 decays, it will emit radiation and decay into a lower energy state. Typically, the lower energy state is stable. However, sometimes the lower energy state will still be radioactive and follow a decay process once again in a process known as a decay chain. The radiation emitted can be in the cases of an alpha emitter or low energy beta emitter only travel a short distance and be contained within the CAB unit 100. However, gamma emitters and higher energy beta particles will ultimately produce x-rays that can travel outside of the CAB unit 104. In many cases, the generation of penetrating radiation necessitates the need for radiation shielding, such as the x-ray shield in FIG. 12.

As shown, subatomic decay particle 973 is a beta decay particle and subatomic decay particle 974 is an antineutrino that interacts with material around, such as to produce Bremsstrahlung x-ray particle 975 radiation. The activated atom 962 (Thulium-170 isotope) decays into decayed atom 963 (Ytterbium-170 isotope), emitting the beta particle 973 and an antineutrino 974. The antineutrino 974 is a weakly interacting material with no future impact; however, the beta particle 973 is a high energy electron. The beta particle 973 itself can only travel a short distance (on the order of 10 s to 100 s of micrometers); the beta particle 973 will interact with nearby atoms to generate x-rays 974 through a process known as Bremsstrahlung. The decayed atom 963 (Ytterbium-170) is a stable non-radioactive atom known as a decayed atom or, at a larger scale, a decayed material.

FIG. 19A illustrates the filling 112 of the CAB unit 104 of FIGS. 10A-B containing precursor material 159 before any charging 1001 occurs. The filling 112 implements a type 1 (wall) encapsulation 802 with a Thulium Oxide precursor material 159. FIG. 19B illustrates the filling 112 of the CAB unit 104 of FIG. 19A after charging 1002 and being exposed to a particle radiation source 101 that is a fission reactor neutron source. The precursor material 159 interacts with neutrons from a fission power source and has converted one out of every four of the precursor isotope 959 (Thulium-169) into the activated isotope 962 (Thulium-170). During the charging process, some fraction of the Thulium-170 will have decayed into decayed isotope 963 (Ytterbrium-170).

FIG. 19C illustrates the filling 112 of the CAB unit 104 of FIG. 19B during operation 1003 producing subatomic decay particles 973A-N (beta radiation 973) that goes onto produce heat that is converted to electricity in a thermoelectric 305 power conversion system of a customer. After charging, the CAB unit 104 is integrated into the CAB stack 200 and CAB pack 300. In FIG. 19C, the CAB unit 300 is integrated with a thermoelectric 305 power conversion system to create electricity. During this time, significant amounts of activated material 162 (Thulium-170) will decay into decayed material 163 (Ytterbrium-170) according to the roughly 4-month half-life, and the beta decay rate and concomitant thermal power production will drop.

FIG. 19D illustrates a depleted filling 112 of the CAB unit 104 of FIG. 19C at the end of operational life 1004. At some time in the future, the decayed material 163 (Ytterbrium-170) will have decayed to the point where its thermal power output will be too small to be useful, and the device will have reached end of operational life 1004.

FIG. 19E illustrates the filling 112 of the CAB unit 104 of FIG. 19D that is now fully depleted 1005. Despite the CAB unit 104 of FIG. 19D being at the end of its operational life, there is still a significant inventory of activated Thulium-170. After approximately 4 years after end of operation (or approximately 12 half-lives) the activated material (radionuclide) 162 will have decayed by a factor of 2¹² or 4096 and the inventory of Thulium-170 has dropped nearly to zero. At this point, the CAB unit 104 can be considered fully depleted.

It is generally desirable to have the activated material 162 to have a half-life close to the mission length. A long mission using a short half-life radioisotope of activated material 162 would run out of power. A short mission using a long half-life radioisotope would be a waste of resources and may need to be safely stored. Traditional Plutonium-238 atomic batteries have an 87-year half-life. For a hypothetical 1-year short mission, Plutonium-238 is not well-utilized. For multi-decade missions to the outer planets, Plutonium-238 has an excellent half-life match.

A key innovation of the CAB technology is that a CAB 190 can be tailored to meet certain mission needs. The precursor isotope 959 can be chosen (based on the half-life of the activated material 162) to meet the lifetime requirement of the mission. The power level of the CAB pack 300 can be modified both by the choice of precursor material 159 and the stacking arrangement in the CAB stack 200. If a mission has tolerance requirements for x-ray radiation 975, either a heavier x-ray shield 301 can be attached, or an activated material 162 can be chosen that emits fewer x-rays 975. The design of the CAB unit 104 can be tailored to meet the needs of a mission; for example a space mission can include an aeroshell 302 to mitigate the damaging effects of plasma encountered during re-entry into the atmosphere from orbital velocities. For space missions, the aeroshell 302 can be important as a safety feature in case of a rocket launch failure to prevent burnup and dispersal of radionuclides of activated material 162 in that scenario. For missions where high temperature tolerance is a requirement, precursor material 159 and encapsulation material 152 can be selected to meet those requirements. This list is not exhaustive and there are many addition ways to customize a CAB pack 300 to meet the mission requirements.

FIG. 20 is a flowchart of a pre-irradiation encapsulation manufacturing method 1100 for a CAB 190. Beginning in step 1105, the pre-irradiation encapsulation manufacturing method 1100 includes selecting (and optionally sourcing) a precursor material 159 and an encapsulation material 152. The precursor material 159 and the encapsulation material 152 are procured in powder formats. Significant research goes into understanding the power morphology and chemical interactions of the precursor material 159 and the encapsulation material 152 to make sure the materials will be chemically and mechanically compatible during the later stages of production while meeting the other fundamental functions of the precursor material 159 and the encapsulation material 152. The step 1105 of selecting the precursor material 159 and the encapsulation material 152 can be based on a respective activation cross-section, a respective particle source irradiation dependent mechanical property, a respective chemical compatibility, a respective high temperature capability, a respective powder property, or a combination thereof.

Continuing to step 1110, the pre-irradiation encapsulation manufacturing method 1100 further includes preprocessing the precursor material 159 and the encapsulation material 152. For example, the powders of the precursor material 159 and the encapsulation material 152 can sometimes require preprocessing by adjusting the grain size using techniques, such as milling and sieving. Calcination may be required to react the powders. Inclusions may be desirable as binding agents. Sol-gel processes may be utilized. Coatings can be applied to powder kernels. There are many other kinds of powder process techniques that may be utilized depending on the needs of the precursor material 159 and the encapsulation material 152.

Some of these operations may be implemented in a fume hood or glove box to safely meet material handling requirements, especially those involved in handling nano-powders and micro-powders. Hence, the step 1110 of preprocessing the precursor material 159 and the encapsulation material 152 includes applying a power processing technique. The power processing technique includes calcination, milling, sieving, or a combination thereof to obtain a desired powder morphology.

In an example, the step 1110 of preprocessing the precursor material 159 and the encapsulation material 152 includes coating the precursor material 159 with one or more precursor encapsulation coatings (e.g., layers) 154-157 formed of the encapsulation material 152 to provide a third level or more of encapsulation.

Moving to step 1115, the pre-irradiation encapsulation manufacturing method 1100 further includes compacting the precursor material 159 and the encapsulation material 152 in a die press process into an unsintered green form, which can be a multi-component green form. The die press process takes the powders of the precursor material 159 and the encapsulation material 152 and compacts the powders. Specialized dies, and multi-step press processes can be implemented to make the multi-component pressed powder compacts, called “green forms,” to achieve the encapsulation types 801-803 described in FIG. 17.

In a first example, the encapsulation material 152 includes an encapsulation wall material. The step 1115 of compacting the precursor material 159 and the encapsulation material 152 in the die press process into the unsintered green form includes producing an encapsulation wall 111 formed of the encapsulation wall material to provide a first encapsulation. In a second example, the step 1115 of compacting the precursor material 159 and the encapsulation material 152 in the die press process into the unsintered green form further includes filling inside the encapsulation wall 111 with the precursor material 159.

In a third example, the encapsulation material 152 includes an encapsulation matrix material. The step 1110 of preprocessing the precursor material 159 and the encapsulation material 152 further includes producing a mixture of the precursor material and the encapsulation matrix material. The mixture of the precursor material 159 and the encapsulation matrix material is a contiguous matrix of the encapsulation matrix material that fully encapsulates the precursor material 159. The step 1115 of compacting the precursor material 159 and the encapsulation material 152 in the die press process into the unsintered green form includes filling inside the encapsulation wall 111 with the mixture of the precursor material 159 and the encapsulation matrix material to form an encapsulation matrix 150 to provide a second encapsulation. In a fourth example, the step 1110 of preprocessing the precursor material 159 and the encapsulation material 152 includes coating the precursor material 159 with one or more precursor encapsulation coatings 154-157 formed of the encapsulation material 152 to provide a third level or more of encapsulation.

Finishing in step 1120, the pre-irradiation encapsulation manufacturing method 1100 further includes sintering the unsintered green form into a CAB unit 104. After creating the unsintered green form for the CAB unit 100, sintering occurs. The sintering process can be achieved through many different methods, such as spark plasma sintering, hot pressing, hot isostatic pressing, and furnaces. In some cases, an inert gas or air may be used. In some examples, additive manufacturing can be used in lieu of or in addition to steps 1105, 1110, 1115, and 1120, for example, to three-dimensional print the CAB 190.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain,” “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A chargeable atomic battery (CAB), comprising:
a plurality of CAB units, each of the CAB units being formed of a precursor compact including precursor material particles embedded inside an encapsulation material,
wherein the precursor material particles include a precursor kernel formed of a precursor material that is in a stable state or an unstable state and convertible into an activated material via irradiation by a particle radiation source; and
a chargeable atomic battery housing to hold the plurality of CAB units.

2. The chargeable atomic battery of claim 1, wherein:
the precursor material particles include one or more encapsulation coatings surrounding the precursor kernel.

3. The chargeable atomic battery of claim 1, wherein:
the one or more encapsulation coatings include graphite, low density graphite, silicon carbide (SiC), titanium carbide (TiC), zirconium carbide (ZrC), niobium carbide (NbC), tantalum carbide (TaC), hafnium carbide, ZrC-ZrB₂ composite, ZrC-ZrB₂-SiC composite, or a combination thereof.

4. The chargeable atomic battery of claim 1, wherein:
the encapsulation material includes silicon carbide, zirconium carbide, titanium carbide, niobium carbide, tungsten, molybdenum, or a combination thereof.

5. The chargeable atomic battery of claim 1, wherein:
the stable state is a stable isotope; and
the activated state is a radionuclide.

6. The chargeable atomic battery of claim 1, wherein:
the unstable state is an unstable isotope; and
the activated state is a radionuclide.

7. The chargeable atomic battery of claim 1, wherein, in the unstable state, the precursor material includes a radioactively-unstable nuclide.

8. The chargeable atomic battery of claim 1, wherein the precursor material includes an oxide, a nitride, a carbide, or a combination thereof.

9. The chargeable atomic battery of claim 1, wherein:
the precursor material includes Neptunium-237, Thulium-169, Europium-151, Europium-153, or Cobalt-59.

10. The chargeable atomic battery of claim 1, wherein:
the precursor material includes Neptunium-237.

11. The chargeable atomic battery of claim 10, wherein:
the activated material includes Plutonium-238.

12. The chargeable atomic battery of claim 1, wherein:
the precursor material particles include coated precursor material particles; and
the encapsulation material includes silicon carbide, zirconium carbide, titanium carbide, niobium carbide, tungsten, molybdenum, or a combination thereof.

13. A chargeable atomic battery (CAB), comprising:
at least one CAB unit, wherein the at least one CAB unit includes:
an encapsulation matrix; and
precursor material particles embedded within the encapsulation matrix.

14. The chargeable atomic battery of claim 13, wherein:
the precursor material particles include one or more encapsulation coatings surrounding a precursor kernel; and
the encapsulation matrix includes silicon carbide, zirconium carbide, titanium carbide, niobium carbide, tungsten, molybdenum, or a combination thereof.

15. The chargeable atomic battery of claim 13, wherein:
the precursor kernel includes Neptunium-237, Thulium-169, Europium-151, Europium-153, or Cobalt-59.

16. The chargeable atomic battery of claim 13, wherein:
the precursor kernel includes Neptunium-237.

17. The chargeable atomic battery of claim 16, wherein:
the precursor kernel is convertible into Plutonium-238 via irradiation by a particle radiation source.

18. A radioisotope thermoelectric generator, comprising:
at least one CAB unit, wherein the at least one CAB unit includes:
an encapsulation matrix; and
a precursor material embedded within the encapsulation matrix, wherein the precursor material particles include a precursor kernel formed of a precursor material that is in a stable state or an unstable state and convertible into an activated material via irradiation by a particle radiation source; and
thermoelectrics coupled to the at least one CAB unit to convert radioactive emissions of the activated material into electrical power.

19. The radioisotope thermoelectric generator of claim 18, wherein:
the precursor material includes Neptunium-237.

20. The chargeable atomic battery of claim 19, wherein:
the activated material includes Plutonium-238.
